(19) United States
(12) Patent Application Publication
(10) Pub. No.: US 2012/0146798 A1
(43) Pub. Date: Jun. 14, 2012

(54) Method of utilizing ionization chambers to detect radiation and aerosolized radioactive particles

(76) Inventors: Michael Dziekan, Bethany, CT (US); Joseph Bango, New Haven, CT (US)

(21) Appl. No.: 12/803,870

(22) Filed: Jul. 8, 2010

Related U.S. Application Data
(60) Provisional application No. 61/270,416, filed on Jul. 8, 2009.

(51) Int. Cl. G08B 17/12; G01T 1/185

(52) U.S. Cl. 340/600; 250/374

(57) ABSTRACT

A detection method that allows a fast, reliable, inexpensive and highly sensitive indication of a release of a radiological aerosol. The release could be of an accidental nature or it could be a deliberate act of terrorism. The release can be abrupt and energetic, such as an explosive surrounded by low-level radioactive medical waste or nuclear waste (dirty bomb), or the release can be stealthy and subtle by silently and clandestinely aerosolizing a low-level radioactive powder into ambient air. The described invention also details how to inexpensively and reliably test for the presence of dangerous radon gas.

### CROSS REFERENCE TO RELATED APPLICATIONS

Provisional Application No. 61/270,416 was filed on 8 Jul. 2009 U.S. Pat. No. 7,196,631 filed on 17 Jun. 2004

### BACKGROUND

1. Field of Invention

This method of detection relates in general to anti-terrorism, and specifically to radiation and radioactive particle detection. The described invention will enable a “smoke detector like” ionization chamber to indicate the presence of aerosolized particles that emit ionizing radiation, such as alpha, beta, gamma, and x-ray. The described invention also describes how a buildings security/fire infrastructure can have enhanced usage for detecting the presence of “dirty bomb” radioactive particle fallout. A “dirty bomb” is a low tech way for a terrorist or adversarial groups to cause mass disruption by releasing ionizing radioactive particles into the air that are capable of causing mass public panic, contamination of buildings, real-estate, and sickness or death in humans and animals. The release can be abrupt and energetic, such as an explosive surrounded by low-level radioactive medical waste or nuclear waste, or the release can be stealthy and subtle by silently and clandestinely aerosolizing a low-level radioactive powder into ambient air.

2. Background Description of Prior Art

In the case of smoke detection by a commercially available ionization smoke detector, a weak radioactive source (such as Americium-241) of ionizing radiation is used to produce ion pairs or air within an ionization chamber. The ionization type smoke detectors take advantage of the ion pairs created by ionizing radiation to develop a small, but measurable ionization current between two plates with a small potential difference between them. The ionization current produced is typically in the range of picoamps (10⁻¹² Amps). Smoke, or smoke-like particles entering the ionization chamber (single or dual chamber design) decrease the ionization current flowing between the two plates and trigger the detector's alarm when a specific threshold is crossed. Contemporary fire alarm systems (or even the detector itself) have intelligent algorithms that compensate for a detectors ionization chamber getting dirty over time and compensate for long term changes in ionization chamber baseline. The intelligent algorithms will reduce the likelihood of a false alarm, and help to prevent an even worse scenario—no alarm when there is a real fire! (see Dziekan “Where there's smoke, there's (not always) fire—An Inside Look at Smoke Detectors”) All current smoke detection methodologies rely on the fact that when smoke or “smoke like” particles enter the ionization chamber, the small but nearly-constant ionization current present in the ionization chamber will rapidly decrease in magnitude to indicate the presence of smoke particles, and sound an alarm. The amount of ionizing radiation will slowly decrease over time (due to its limited half-life), and will correspondingly produce a decreased ionization current, but this would most likely be on the order of decades. It is worth noting that the source of ionizing radiation typically used (Americium-241), has a half-life of approximately 432 years, and will not last forever as an ionizing source. Ionization type smoke detectors have also been falling in popularity over the past several years, and fewer and fewer are being produced. The intent of this invention is to enable a means of “dirty bomb” detection by utilizing the same basic construction of a typical ionization type smoke detector, with one significant change and only minor alterations. The described invention utilizes a dual ionization chamber that does not contain any permanent ionizing source of radiation. It is important to note that by removing the permanent source of ionizing radiation, it will no longer be possible for the ionization chamber to detect smoke or smoke-like particles. By removing the permanent source of ionizing radiation, the “smoke detector” cannot function as a smoke detector any longer, and can therefore no longer be considered a smoke detector! The ionization chamber will retain the basic features as it does in a normal ionization type smoke detector, with the exception that there will no longer be any ionization current. The lack of ionization current is due to the fact that the ionization chamber does not contain any permanent radioactive material, such as the typical Americium-241. In commercially available ionization type smoke detectors, a dual chamber design is used to monitor and compensate for changes in atmospheric conditions (such as barometric pressure changes, and changes in humidity levels) so as to prevent a false alarm. The ionization type smoke detectors ionization chambers ionization current is sensitive to the density of gas (ambient air) and water vapor that is inside the ionization chamber. If there are a greater number of air molecules per unit volume, the result is that up to a point, there will be a resulting greater magnitude of ionization current. If there are fewer air molecules per unit volume, the result is that there will be a smaller magnitude of ionization current, which could result in a false alarm if the smoke detector was not of the dual chamber design. This assumes that the radioactive source remains relatively constant. Two completely identical ionization type smoke detectors will have different baseline ionization current values if operated at different altitudes, such as one in Death Valley, and another in Colorado, therefore the ambient atmospheric conditions must be taken into account for reliable operation, which is true for a dual ionization chamber design.

For detecting particles that emit ionizing radiation, the preferred embodiment of the described invention utilizes a similar dual ionization chamber design, where each ionization chamber has a small voltage applied across its two isolated plates, with the only significant difference being that the permanent ionizing radioactive source is removed from each chamber. In normal operation (i.e. no ionizing radiation or particles that emit radiation are present), there will be no ionization current or only a small amount due to atmospheric ions. Too many people are worried about working with ionizing radiation, and many manufacturers have stopped manufacturing ionization type smoke detectors, even though the amount used is virtually insignificant. The described invention does away with the permanent ionizing source of radiation, and makes for an environmentally friendly radiation and radioactive particle sensor.

It is important to point out that the term “radioactive particle” or “radiological particle” used throughout the text in this patent will refer to a small (sub-micron sized to several hundred microns) particle of material that emits ionizing radiation. The particle can be either naturally or artificially radioactive. The ionizing radiation emitted by the radioactive particle will be in the form of alpha, beta, gamma, or x-ray radiation. To avoid confusion, anytime the term “radioactive particle” or “radiological particle” is used, it is used to signify a tiny particle (micron sized) of material that emits ionizing radiation in the form of alpha, beta, gamma, or x-ray radiation. As stated earlier, the ionization type smoke detector that is constructed without any source of ionizing radiation will never function as a smoke detector, and can therefore no longer be considered a smoke detector. The new use will be to detect ionizing radiation and small aerosolized radiological particles that emit ionizing radiation. If a “dirty bomb” is exploded or aerosolized radioactive particles are released into the atmosphere in what will most likely be a large metropolitan area (if terrorism is involved), a method of indication can be realized to warn building occupants that there is a quantity of harmful radioactive particles in the air. Since this new device will have a singular specialized use of detecting ONLY a source of ionizing radiation or radiological particles that emit ionizing radiation, a new and unique alarm will most likely be needed to warn building occupants of dangerous radiation. This alarm should be clearly distinguishable from typical fire and smoke alarm warnings. The described invention will be referred to from here on out as a “RADiationless iOnization SEnsor” or RADOSE. If the RADOSE is operating in an environment that is free from ionizing radiation, there will be little or no ionization current since there isn't any source of ionizing radiation to create ions from the neutral air molecules inside the ionization chamber. There would be some small background ionization current due to the continual supply of atmospheric ions that are all around us. Atmospheric ions are created by interaction of neutral air molecules and cosmic rays, ultraviolet light, ionizing radiation, and also by fire and other heat sources. (See Carlson, “Counting Atmospheric Ions”)

In a typical ionization type smoke detector, the ionization current is at a maximum when there is no smoke or “smoke like” particulates that can occlude the ionization chambers ionized air molecules. When smoke particles or “smoke like” particles are present in the ionization type smoke detectors ionization chamber, the ionization current decreases in magnitude, and when the ionization current drops to a low enough predetermined threshold level, a smoke alarm is sounded. The RADOSE on the other hand works in an opposite fashion—when there is no radiation or radioactive particles present in the ionization chamber, the ionization current is very nearly zero, since there is no source of ionizing radiation to create ionization current. When the RADOSE is exposed to ionizing radiation—either by being placed near a strong source of ionizing radiation, or if radiological particles make their way inside the RADOSE ionization chamber—the net result is that the neutral air molecules inside the RADOSE ionization chamber will start to become ionized by the ionizing radiation—the stronger or greater the amount of the ionizing radiation, the greater the ionization current. As the previously neutral air molecules inside the RADOSE ionization chamber become ionized, the small potential difference between the two plates of the ionization chamber will prevent recombination, and cause the ions to separate and produce a small, but measurable ionization current. This small ionization current can be detected and sound an alarm to warn occupants that a radioactive aerosol has been detected in the immediate vicinity. A radioactive aerosol is considered to be a plume (either visible or invisible to the naked eye) of small radioactive particles, that are either intentionally released into the air (in the case of terrorism), or accidentally released into the air. The RADOSE can function as a standalone device and/or it can be incorporated into a buildings Fire and security infrastructure. The building fire and security infrastructure must be taught how to handle the information from the RADOSE. There are several basic ways too accomplish this. One way is to connect a set of contacts—such as the contacts of a relay that can close or open in the case of a radiological detection alarm from the RADOSE—to a monitor module that has been programmed in the fire or security panel to identify it as a “Radiation Alarm” or “Radioactive Aerosol Alarm”. Another way is to create a special software identification type in the fire or security panel that will uniquely identify the RADOSE as an addressable radiation or radioactive particle sensor, and can have more flexibility in sounding an alarm or warning. An addressable sensor is one that can be connected to a common signaling line circuit (SLC), but has a unique identifier that distinguishes it from all other attached sensors on the common SLC line.

A software modification to the fire or security panel will be the addition of a new alarm (possibly called “Radiation Alarm”, “Radioactive Particle Alarm”, or whatever else is mandated by the local authority having jurisdiction—LAHJ) that will be sounded if one or more of the RADOSE devices indicate detection of ionizing radiation or radioactive particles. The alarm can cause specific life saving events to be triggered from the fire or security panel; such as, closing outside air dampers, and turning off ventilation fans to minimize the amount of dispersion of a radioactive aerosol that would be introduced into the building ventilation system.

### BRIEF DESCRIPTION OF THE DRAWINGS

FIG. 1 shows a schematic representation of an ionization chamber that would be used in a typical commercially available ionization type smoke detector.

FIG. 2 shows a schematic representation of the ionization chamber indicating the presence of ions caused by interaction between the ionizing radiation and the air molecules present inside the ionization chamber.

FIG. 3 shows a schematic representation of the ionization chamber with the introduction of smoke or “smoke like” particles.

FIG. 4 shows a schematic representation of the ionization chamber with the absence of smoke/combustion and radioactive particles, showing only the neutral air molecules that are inside the ionization chamber.

FIG. 5 shows a schematic representation of an ionization chamber showing the introduction of ionizing radioactive particles into the ionization chamber.

FIG. 6 shows a schematic representation of dual chamber operation of the described invention with a reference (left) ionization chamber and a sample (right) ionization chamber.

FIG. 7 shows a plot that illustrates ion pair production of Americium-241 as a function of distance through air.

FIG. 8 shows a plot that illustrates background ionization current produced by background atmospheric ions over time.

FIG. 9 shows a plot that illustrates background ionization current produced by background atmospheric ions over time and exposure to radioactive particles.

FIG. 10 shows a plot that illustrates the reference chamber and sampling chamber background ionization currents produced by background atmospheric ions over time and exposure to radioactive particles.

FIG. 11 shows a flowchart detailing the operation of the described invention.

### DETAILED DESCRIPTION OF THE INVENTION

Before discussing the detailed operation of the RADOSE, it is important to clarify some possible ambiguity of the term “radioactive particle”. In the case of beta radiation, the ionizing radiation is an energetic electron or positron. In the case of gamma and x-ray radiation, the ionizing radiation is an energetic photon. In the case of alpha radiation, the ionizing radiation is an energetic helium nucleus. There are other types of ionizing radiation, but the scope of this patent will be to focus on detection of material that emits alpha, beta, gamma, and x-ray ionizing radiation. The term “radioactive particle” or “radiological particle” in the context of this patent is used specifically to describe small particles, such as a coarsely to finely ground powder or a liquid composed of material that emits ionizing radiation in the form of alpha, beta, gamma, or x-ray ionizing radiation. A radioactive powder that is composed of micron sized (10⁻⁶ meter) particles that produce ionizing radiation will be the considered a “radioactive particle” or “radioactive particles” in the context of this patent, where each individual micron sized particle emits ionizing radiation. A radioactive liquid that has been aerosolized and produces ionizing radiation will also be considered a “radioactive particle” or “radioactive particles” in the context of this patent. The term “radioactive particle” will also be used synonymously with the term “radiological particle”, and will convey an identical meaning. The term “radiological aerosol” or “radioactive particle aerosol” will be used interchangeably and describe an aerosol composed of one or more “radioactive particles” or “radiological particles”.

If a terrorist is building a “dirty bomb”, their goal is to spread as much radioactive material over as wide an area as possible. A means for accomplishing this will be to have a radioactive source that is easily dispersed, such as in the form of a liquid or a finely ground powder. If the radioactive particles are of a fine enough size (micron sized), the dispersion will be greater, and unfortunately, so will the damage and risk to human life. There may be an occasion where a “dirty bomb” does not have to be energetically dispersed (exploded), and the radioactive particles can be released as a nearly invisible radioactive aerosol that is completely silent and will most likely go unnoticed. There could be a time delay of hours, days, weeks, months, or even years before a clandestine release of a radioactive aerosol is ever detected. The described invention details a method of detecting such a clandestine, accidental, or overt release in near real-time, enabling great savings to life and property.

To explain how the RADOSE differs from existing, commercially available ionization type smoke detectors, it will be prudent to first discuss the normal operation of a commercially available ionization type smoke detector in addition to some basic fire panel operation. In commercial fire or security systems, there are two main types of panel operation, addressable, and non-addressable. Addressable refers to the ability of the fire panel to query individual smoke detectors and modules (Note—Since only smoke detector operation is of relevance, no mention will be made for the usage of modules). For example, a series of smoke detectors could be connected to the main communication line (typically referred to as the SLC, or Signaling Line Circuit) that provides not only communication, but also power. If one-hundred detectors are connected to the SLC line, each can be uniquely addressed on an individual basis. The number one-hundred is not set as a limiting factor, but is used for an example because different fire and security panels have different capabilities. The maximum number of detectors or modules will depend on a variety of factors, such as wire length, gauge, impedance, device current draw, SLC connection style, etc. The individual smoke detectors addresses are usually set by the installer by a variety of means, such as setting a set of rotary switches to the desired unique address. As the fire or security panel queries detector number one, the detector will send back its chamber value to be read by the fire or security panel. It is important to note that some smoke detectors report back a “chamber value” that acts oppositely of the actual measured ionization current. For example, a value of high measured ionization current (smoke free environment) could indicate a detector chamber value of a very low number, while a value of low measured ionization current (smoke present) could indicate a chamber value of a much higher number.

The fire or security panel will analyze this information, convert it, and determine if the chamber value is high or low. If the reading is high, it will most likely mean that smoke, or more accurately, particulates impeding the ionization current flow in the ionization chamber are present inside the smoke detectors ionization chamber. The fire or security panel can then process the information through a suitable algorithm to determine if the system should report a dirty chamber, maintenance condition, alert condition, warning condition, or full alarm condition. Typical commercial fire alarm or security panels function with either individually addressable devices, or non-addressable groups of devices. Non-addressable devices cannot be individually mapped to specific areas, but can only be mapped as a group.

In an addressable system, one could map individual detectors to a graphical floor plan, or a computerized graphical floor plan that can be displayed on a computer video monitor. If detector number one indicates an alarm condition, a label could be displayed along with the alarm condition, such as “ALARM (Smoke): Main Lobby East”, or “ALARM (Smoke): Pump Room”. This gives rapid information as to the affected locations of the protected premises that are indicating smoke or fire. The ionization chamber ionization current value in an ionization type smoke detector will always be at its maximum or highest value when there is no smoke or “smoke like” particulates within the ionization chamber. There could be a small amount of dirt or dust that could buildup within the ionization chamber over time, or a gradual weakening of the ionization potential from the radioactive source that will cause some degradation of ionization current. Virtually every intelligent commercial fire or security panel will compensate for this slow decrease in ionization current with a specific ionization chamber compensation algorithm. The algorithm will enable a “normal” baseline value to be established, and any rapid decrease in ionization current below this value will constitute a warning or alarm condition. This type of adjustable baseline algorithm prevents many false alarms from happening that could result from a “normal” no smoke condition. (see Dziekan ““Where there's smoke, there's (not always) fire—An Inside Look at Smoke Detectors”) It is important to note that the baseline determination is a relatively slow and gradual process, if it reacted too quickly to any decrease in ionization chamber current, then it would most likely miss any true alarm condition. If the ionization chamber compensation algorithm compensates for this relatively slow and gradual decrease in ionization current, then the alarm point could be set just above what is considered a normal value. Instead of a false alarm being sounding, the new alarm value or adjusted alarm value would be the baseline setting plus some additional headroom above what is considered “normal”. All these things help to improve fire or security panel operation and reduce the number of subsequent false alarms.

Prior to the tragedies of 9/11, little thought has been given to what happens if an ionization type smoke detectors ionization current increases. The inventors have been awarded U.S. Pat. No. 7,196,631 that discloses how to utilize existing ionization type smoke detectors to detect for the presence of aerosolized radioactive particles. The commercial market for ionization type smoke detectors has been steadily declining, and many of the existing ionization type smoke detectors are being replaced by different detection types, such as photoelectric. The disclosed invention describes how to make a new and novel radioactive particle sensor, similar in construction to ionization type smoke detectors, but without the need for any permanent ionizing radioactive material for its operation. The new and novel radioactive particle sensor can be made to operate either stationary by being temporarily or permanently affixed to an immobile structure, or completely self contained and portable.

With existing commercially available ionization type smoke detectors, it has been shown how an increase in the smoke detectors ionization current would correlate to an increase of radioactive particles inside the ionization chamber. (Dziekan et al. U.S. Pat. No. 7,196,631) This increase in ionizing radioactive particles, such as those released by an energetic explosion of a “dirty bomb”, or as a result of silently releasing aerosolized radioactive particles, will cause the neutral air molecules within the ionization chamber to become ionized, and hence, the ionization chambers ionization current will increase. The only possible ways for the ionization current in the ionization chamber to increase, is that the radioactive source has increased in strength (become more radioactive), the gaseous mixture inside the ionization chamber has been changed from air, to some other type of gas, or the atmospheric pressure has greatly increased. The first two conditions are extremely improbable, and the last condition will not cause a problem to the ionization type smoke detector where a dual chamber ionization type smoke detector is used. The only logical reason left for an increase in ionization chamber current (short of a malfunction of the ionization type smoke detector) is that excess ions are present within the ionization chamber. Since alpha radiation will only travel a few centimeters (10⁻³ m) in air before being completely stopped, it would mean that a radioactive particle, such as one emitting alpha, beta, gamma, or x-ray radiation has been introduced into the ionization chamber. Unlike alpha radiation (Ionizing particle), radioactive particles can travel large distances (up to thousands of yards) and this means that the ionization detector could indirectly be capable of detecting radiation by detecting the presence of radioactive particles. The same is true for radioactive particles that emit beta, gamma, and x-ray radiation. Beta radiation will travel much further in air than will alpha radiation, while gamma and x-ray still further; however alpha radiation has a greater ionizing effect on air molecules. The described invention can detect both, ionizing radiation emitted by objects that are in the local vicinity of the RADOSE sensor as well as radioactive particles from a “dirty bomb” or radioactive aerosol. As mentioned earlier, alpha radiation (Ionizing particle) can only travel a short distance in air before being stopped, with beta able to travel still further, and gamma and x-ray the furthest. It is impossible to detect alpha radiation in air from a distance of more than a few centimeters, but it is quite easy to detect radioactive particles that emit “ionizing particles” such as alpha radiation if they enter into an ionization chamber. With the radioactive particles that emit alpha radiation introduced into the ionization detectors ionization chamber, the distance that the alpha radiation has to travel is now only about two to four centimeters—well within detection range. The ionizing particles emitted by the radioactive particles inside the ionization chamber will cause an increase from the normal (near zero) value of ionization current to some increased value that is only possible due to the ionization of the previously neutral air molecules inside the ionization chamber of the RADOSE sensor. The ability for radioactive particles and radiation (ionizing particles) to ionize air molecules and produce an ionization current inside an ionization chamber is the basis for the described invention. The descriptions of smoke detectors or “smoke detector like” devices is to convey the fact that similar construction techniques and operational characteristics will be utilized, based on the fact that smoke detectors have long been studied to provide an efficient means for detecting airborne particles such as smoke.

Commercially available ionization type smoke detectors can be made of a single ionization chamber design or a dual ionization chamber design. The RADOSE sensor will be constructed in a similar fashion, utilizing either a single ionization chamber or dual ionization chambers. It must be noted that both single and dual ionization chambers will work for this application; however, in the preferred embodiment of the described invention, dual ionization chambers will be utilized in the RADOSE sensor. The atmosphere has some component of atmospheric ions that can cause an “ionization current” to be seen inside the ionization chamber of the RADOSE sensor. If a dual ionization chamber construction is utilized, the result is that a “reference chamber” can be used to monitor the ambient atmospheric conditions. The “reference chamber” is constructed in such a way as to allow only ambient air molecules and water vapor inside the “reference chamber” while blocking any particulates from entering. This can be accomplished by surrounding the reference chamber with a thin flexible membrane with small pores or holes that will block any micron sized or larger particles from entering, while allowing only air molecules or water vapor to pass through. This is a common construction technique used in making commercial ionization type smoke detectors. The “sampling chamber” or “active chamber” is constructed in such a way as to allow any and all large particulates inside as well as ambient air molecules and water vapor. The difference in ionization current between the “sampling chamber” and the “reference chamber” will help reduce the quantity of potential false alarms, because atmospheric ions will be sensed inside both, and the difference between the two will be very nearly zero, since the atmospheric ions will be common to both. A valid reading will be for the difference between the two chambers (reference and sampling) to be measured. A sudden thunderstorm could produce transient, abnormally high quantities of atmospheric ions, and thus could cause a single ionization chamber device to produce a false alarm. If a reference chamber is utilized along with a sample chamber (as in the case of a dual chamber device), any transient, rapid changes in ambient atmospheric ions will affect both chambers simultaneously, with the difference between the two chambers being zero or very nearly zero. If a single ionization chamber were utilized in construction, a high degree of false alarms could be noted.

Alpha radiation is composed of a doubly charged helium nucleus, i.e. a helium atom with its two electrons stripped off. Alpha radiation has very little penetration power and a few centimeters of air or a sheet of paper will easily block it. If alpha radiation were released from a radioactive source, the alpha radiation would travel only a few centimeters in air, and would therefore be undetectable at a greater distance; however, if a radioactive particle that emits alpha radiation were released into the air, it would be detected if it were introduced into the RADOSE sensors sampling ionization chamber, even if the release of radioactive particles happened many thousands of yards away. If a dirty bomb is exploded, the small radioactive particles could potentially travel thousands of yards, or more from the point of origin. If a radioactive powder were aerosolized from a moving vehicle, such as a car, bike, boat, or plane, the particles could potentially travel many miles, and contaminate an area of many square miles.

It is well understood how ionization chambers function, and the described invention utilizes construction methods that are virtually identical to those used to construct ionization chambers that are commonly found in ionization type smoke detectors. Both ionization chambers (reference and sample ionization chambers) operate by sampling ambient air; however, only the sample ionization chamber has openings large enough to allow large particles to penetrate into the sample ionization chamber. Ionization chambers can typically operate in one of three different modes of operation, current mode, pulse mode, and charge integration mode. Just like ionization type smoke detectors, the RADOSE sensor will operate in the current mode, where an ionization current is produced by a supply of ions. Some ionization chambers are sealed, gas-filled chambers with a unique gas or gas mixture at a specific pressure, but it should be understood that the RADOSE sensor will utilize “open” ionization chambers, where the gas within them is normal air at atmospheric pressure. The term “open” means that both ionization chambers are not sealed, and will allow ambient air and water vapor to enter, while only the sample ionization chamber will allow large (micron sized or larger) particles, as well as ambient air and water vapor to enter. The reference ionization chamber has openings that will block large particulates from entering, while the sample ionization chamber will allow the large particulates to enter. Neither ionization chamber (reference or sample ionization chamber) is hermetically sealed or contains a pressurized gas, but both are open in the sense that ambient air and water vapor can freely enter each of them. The reference ionization chamber is constructed with tiny pores that allow air and water vapor to enter, while blocking large particulates from entering. In the context of this patent, anytime the term “gas” is used when discussing the operation of an ionization chamber, the gas is to be understood as being ambient air at normal atmospheric pressure, along with any ambient water vapor. Depending upon the electric field strength within the ionization chamber, there are several potential modes of operation.

If the electric field within the ionization chamber is too low or zero, recombination of any ions created by radioactive particles within the ionization chamber will occur. Recombination is where the electric field strength within the ionization chamber is too low to prevent ion pairs from completely recombining and very little to zero ionization current would be measured. As the electric field strength within the ionization chamber is increased, more and more ion pairs are prevented from recombining and a weak ionization current can be measured. If the voltage potential difference across a typical ionization chamber is zero or less than approximately ten volts dc, recombination will continue to dominate, and there will be little to no ionization current.

If the electric field within the ionization chamber is further increased to a point where any recombination becomes insignificant, a stable ionization current will be produced. The ionization mode is where the electric field strength within the ionization chamber is of a high enough magnitude where the quantity of ion pairs that recombine becomes insignificant and the majority of ions are available to produce an ionization current. With a potential difference of approximately ten volts across the ionization chamber, the electric field strength within the ionization chamber prevents nearly all recombination and a fairly steady ionization current (picoamps 10⁻¹² amps) would be produced if any radioactive particles enter the ionization chamber. With no radioactive particles within the ionization chamber, only atmospheric ions will be available to produce a small ionization current. The presence of any radioactive particles within the ionization chamber will produce a much greater quantity of ion pairs than atmospheric ions within the ionization chamber and thus produce a greater magnitude of ionization current. If the magnitude of ionization current produced is greater then a predetermined alarm threshold, an alarm condition would be indicated.

The electric field within the ionization chamber can be further increased to a point where gas multiplication takes place within the ionization chamber. This has the effect of producing more ion pairs, and hence, a greater ionization current. If the electric field within the ionization chamber is further increased to a point far above the threshold of gas multiplication, to a magnitude where a continuous discharge through air is realized, the ionization chamber will produce a continuous and substantial ionization current, and will be useless for detecting radiation or radioactive particles. For the preferred embodiment of the described invention, the electric field within the ionization chamber will be high enough to prevent recombination so as to produce a reasonable amount of ionization current, but low enough so that there will be no danger of operating in a continuous discharge mode.

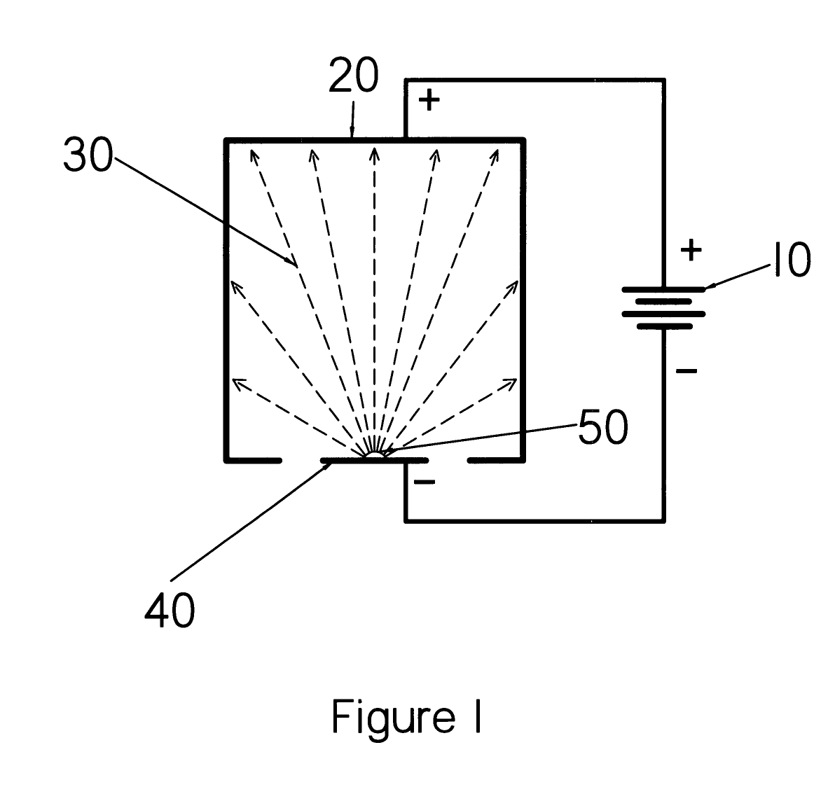

FIG. 1 shows an ionization type smoke detectors ionization chamber. A small ionizing radioactive source 50 (typically Americium-241) is placed inside a cylindrical metal ionization chamber 20 that causes ionizing particles to interact with neutral ambient air molecules within the ionization chamber let in through small openings, to produce ion pairs. A stream of ionizing particles 30 are emitted from the radioactive source 50. A small dc voltage source 10 is connected to opposing sides of the ionization chamber to create a potential difference across the chamber, and produce an electric field within the ionization chamber. There is a positive side 20 and a negative side 40 that are electrically isolated from one another.

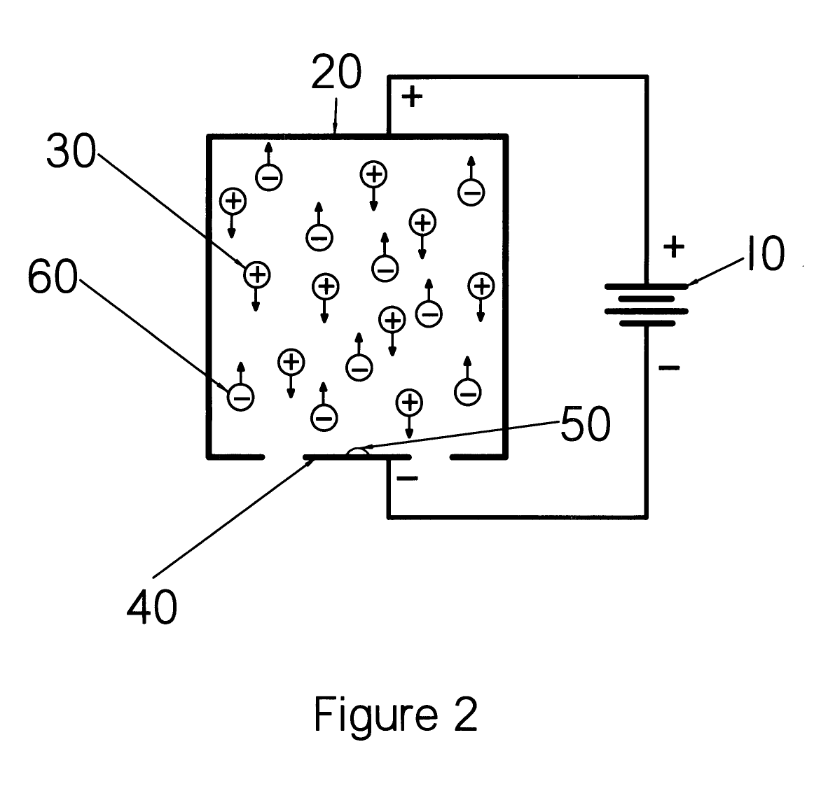

FIG. 2 shows ion pairs of air molecules produced from the interaction of the ionizing radiation (ionizing particles) produced by the radioactive source 50. The ion pairs will have a mix of positive 30 and negative 60 ions. Due to the presence of the voltage source 10 across the ionization chamber, recombination of ion pairs will be prevented because there will be an attraction for the positive 30 ions to head towards the negative plate 40, and an attraction for the negative 60 ions to head towards the positive 20 plate. This attraction will cause a small ionization current to develop (typically picoamps (10⁻¹² amps) of current) which can be measured quite easily, as is commonly done in ionization type smoke detectors. The steady presence of ionization current indicates that there are no particulates interfering with the ion pairs, i.e. no smoke/combustion products are present within the ionization type smoke detectors sampling ionization chamber.

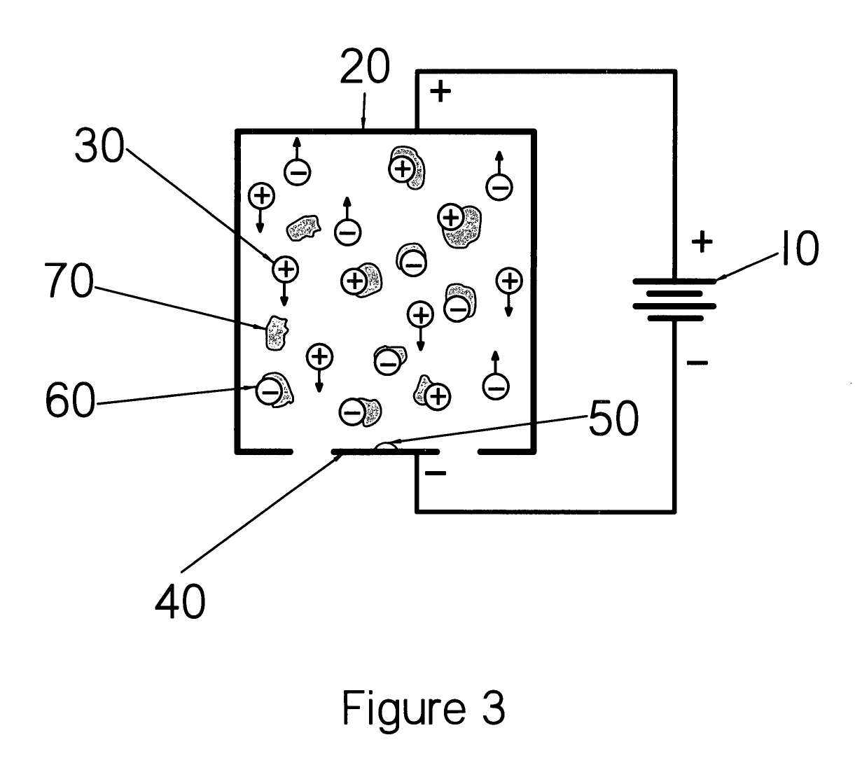

FIG. 3 indicates the presence of smoke/combustion products 70 that are introduced into the sampling ionization chamber of a typical ionization type smoke detector. As the large smoke/combustion particles interact with the positive 30 and negative 60 air ions, the quantity of uninterrupted ion pairs that are left to make up the ionization current is greatly decreased, and hence, the magnitude of the ionization current is also decreased. The ion pairs are prevented from recombining due to the external dc voltage applied 10. The dc voltage enables separation of the ion pairs, but due to the presence of smoke/combustion products 70 within the ionization chamber interfering with the ion pairs, there are fewer ion pairs to produce an ionization current. This reduction of ionization current is an indication of the presence of smoke/combustion products, and a subsequent alarm or warning is sounded based on either the detectors alarm threshold values, or the fire alarm panels internal programmed alarm threshold values. All current ionization detectors make use of the fact that a reduction of ionization current will indicate the presence of smoke/combustion products, and subsequently, a fire. This makes sense because the amount of ionizing radiation inside the chamber produced by the radioactive source 50 does not change (aside from some decrease due to aging). There will be a slow decrease in emitted ionizing radiation over a period of several decades (the half-life for Americium is approximately 432 years).

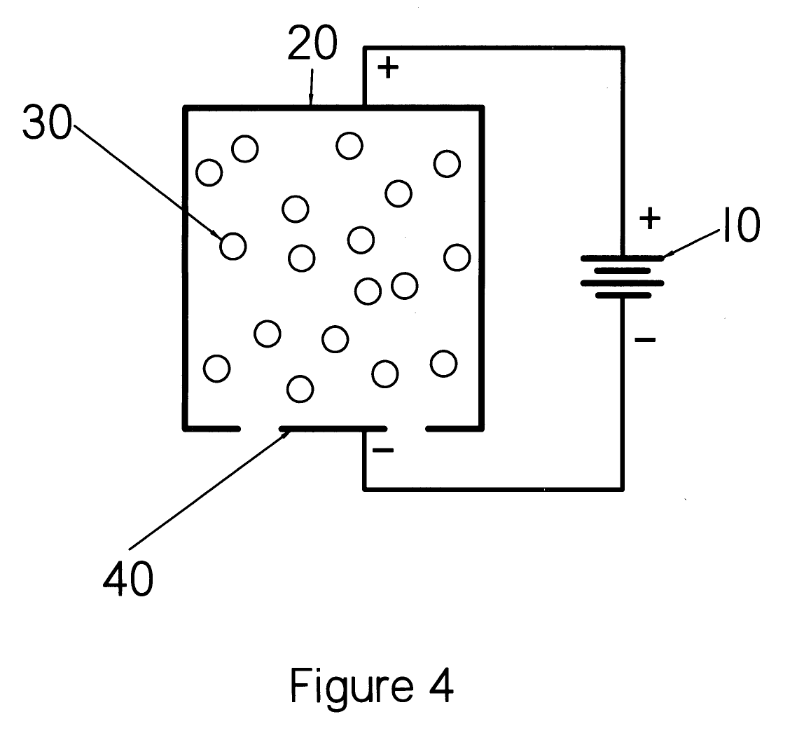

FIG. 4 shows how the RADOSE sensors ionization chambers are distinctly different from that of typical ionization type smoke detectors. The RADOSE sensor utilizes ionization chambers in which both are free from any permanent source of ionizing radiation. The RADOSE sensors ionization chambers contain neutral air molecules 30 due to the fact that the ionizing source commonly used in typical ionization type smoke detectors is not used. Since the majority of air molecules 30 are in a neutral state, there is no resulting ionization current produced by the ionization chamber. The ionization chamber has two opposing plates that are electrically isolated from each other, that have a small dc potential difference 10 applied to them. One plate is positive 20, and the other is negative 40, each electrically isolated from each other. The voltage source 10 supplies the potential difference across the two electrically isolated plates. If the air molecules remain in a neutral state, there will never be any ionization current produced. The only way for the air molecules within the ionization chamber to remain in a neutral state is for the ionization chamber to remain free from ionizing radiation, radioactive particles, or atmospheric ions. There can be a small ionization current due to the fact that atmospheric ions may make their way into the ionization chamber.

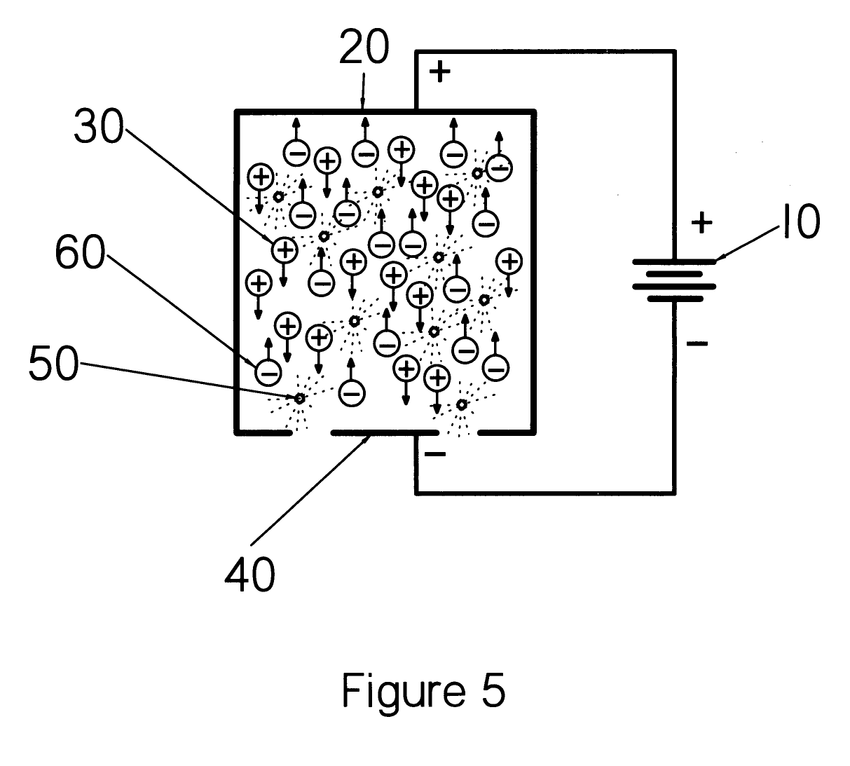

FIG. 5 shows the basis of the invention. The RADOSE sensors ionization chamber does not contain any permanent source of ionizing radiation, but radioactive particles 50 from an external source, such as a “dirty bomb” have been introduced into the sample ionization chamber. The radioactive particles 50 have the ability to ionize the previously neutral air molecules into positive 30 and negative 60 ion pairs. The ionization chamber has two opposing plates that have a potential difference applied to them. One plate is positive 20, and the other is negative 40, with each electrically isolated from each other. The voltage source 10 supplies the potential difference across the two plates. It should be obvious to those skilled in the art that the term “plate” used to describe the structure of the ionization chamber, can be used to describe a flat conductive plate, a conductive ring, or a conductive cylinder. The air molecules are now ionized by the ionization radiation emitted from the radioactive particles 50 and can now produce ionization current. The resulting ionization current that is produced will indicate the presence of radioactive particles, since the radioactive particles must also be present in the ambient air to have made their way into the ionization chamber.

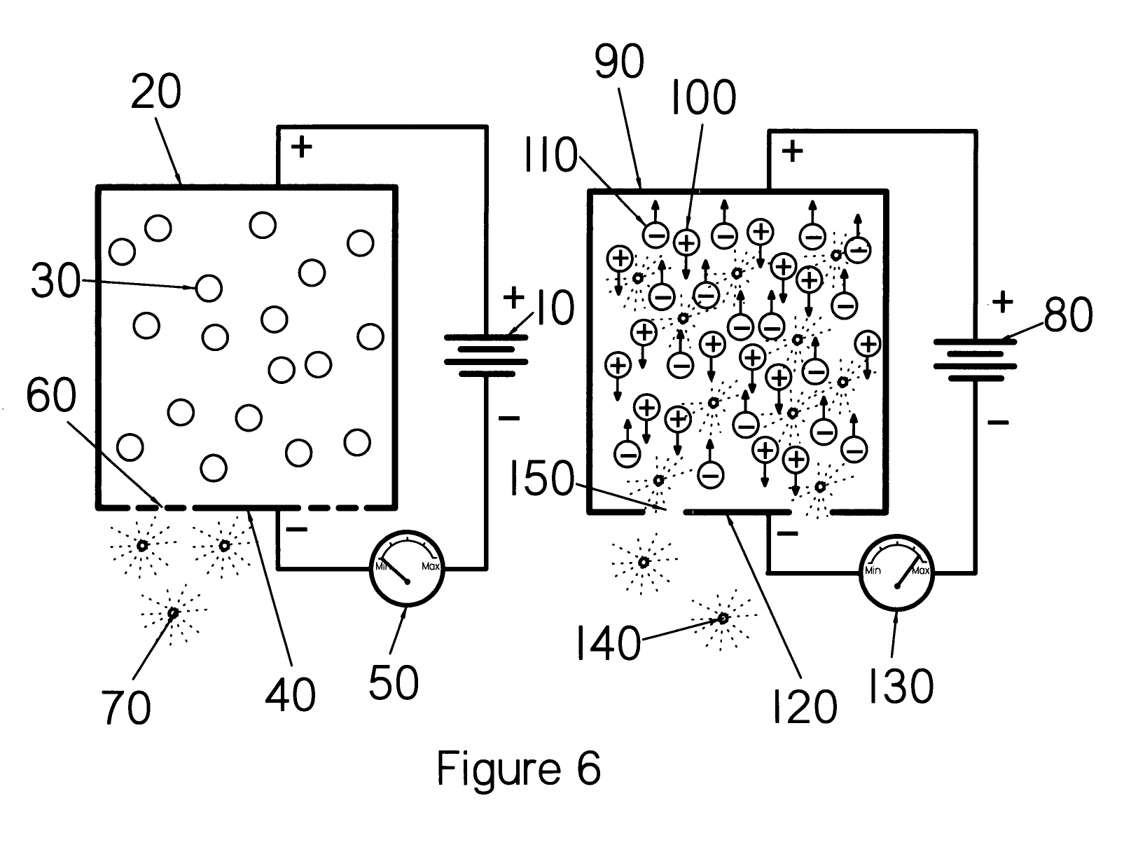

FIG. 6 shows a schematic representation of the preferred embodiment of the described invention. Dual ionization chambers are utilized (both are constructed without any permanent source of ionizing radiation such as is typically used in ionization type smoke detectors), with one ionization chamber serving as a reference ionization chamber (left image), and the other ionization chamber serving as a sample ionization chamber (right image). Both ionization chambers are housed within the same detector, just as in traditional ionization type smoke detectors. The reference ionization chamber has very small pores 60 that allow only air molecules, atmospheric ions, and water vapor to penetrate inside the reference ionization chamber. Any large particles or particulates are prevented from entering the reference ionization chamber because the small size of the reference ionization chambers pores 60 blocks them from entering. Any large radioactive particles 70 are prevented from entering the reference chamber due to the fact that they will be too large to penetrate the small pores 60. The air molecules 30 inside the reference ionization chamber remain predominantly neutral because there is no source of ionizing radiation within the reference chamber to ionize them. The dc voltage source 10 is used to provide a steady potential difference between two electrically isolated plates that make up the RADOSE reference ionization chamber. An electrically isolated positive plate 20 and negative plate 40 are used to provide a means for preventing recombination of ion pairs, separating the ion pairs and creating an ionization current. Since there is no source of ionizing radiation inside the reference ionization chamber, the air molecules within the reference ionization chamber remain in a predominantly neutral state. A schematic representation of an ammeter 50 is shown to indicate the lack of any ionization current produced within the reference ionization chamber, due to the fact that the radioactive particles 70 are prevented from entering the reference ionization chamber. Although large particles and particulates can only enter the sample ionization chamber, it is possible for a small ionization current to be induced inside both the RADOSE sensors reference ionization chamber and the sample ionization chamber due to the presence of atmospheric ions. Since the difference between the two ionization chambers is being measured, there will be no resulting differential ionization current. The sample ionization chamber has much larger pores 150 that easily allow large (micron sized) radioactive particles 140 to enter. As the radioactive particles 140 enter into the sample ionization chamber, the previously neutral air molecules are now forming ion pairs, with negative 110 and positive 100 ions. The voltage source 80 for the sample ionization chamber provides a potential difference between the electrically isolated positive electrode 90 and the negative electrode 120 of the sample ionization chamber. The ion pairs produced within the sample ionization chamber by the ionized air molecules are now capable of producing an ionization current. A schematic representation of an ammeter 130 indicates the presence of the ionization current produced by the sample chamber. The result of the production of an ionization current from the sample ionization chamber is that an alarm can be reliably produced to indicate the presence of radioactive particles, such as would be indicative of a “dirty bomb” explosion or a clandestine, silent release of radiological particles constituting a radiological aerosol.

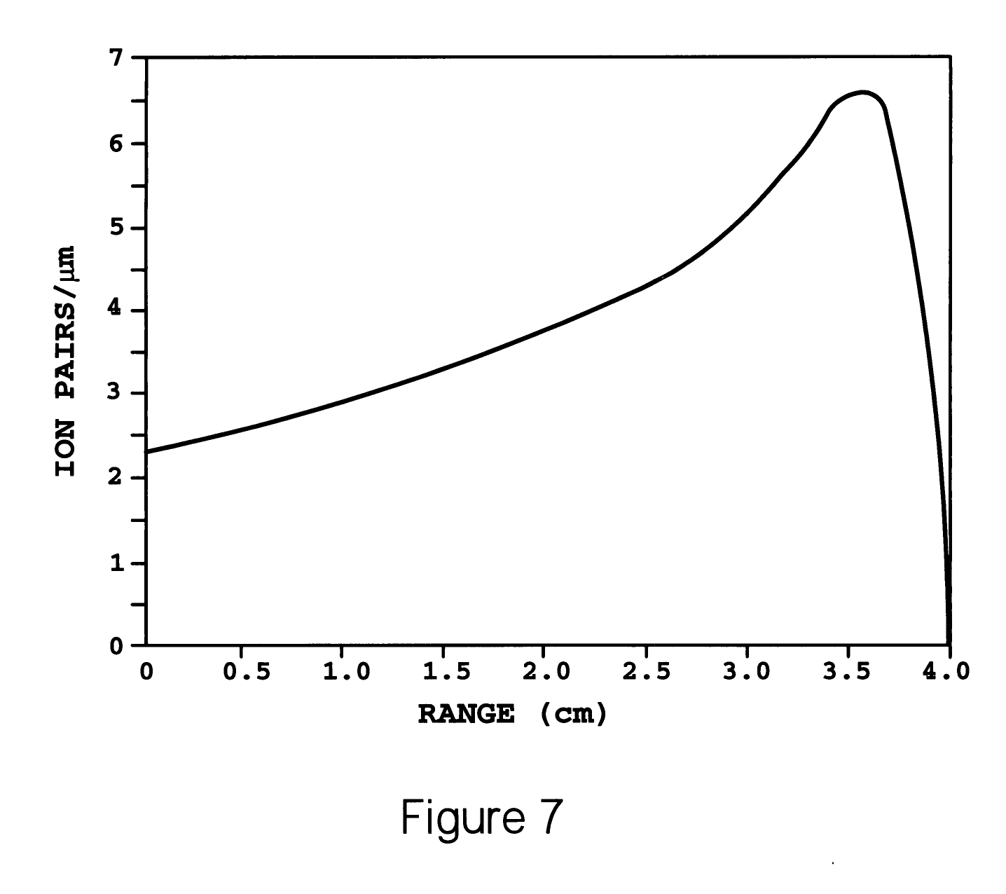

FIG. 7 shows a plot that illustrates ion pair production of Americium-241 as a function of distance from the ionizing source through a gas—in the context of this patent; the gas will be understood to be ambient air that is at atmospheric pressure containing a similar amount of water vapor that is found in ambient air external to the RADOSE sensors ionization chambers. The air within the RADOSE sensors ionization chambers will be identical to the air that is external to the RADOSE sensors ionization sensors, with the only exception being that any large particles or particulates in the ambient air will be blocked from entering the RADOSE sensors reference ionization chamber. The graph illustrates specific ionization per unit distance—in the context of this patent; the specific ionization will be on the order of ion pairs produced per micron (10⁻⁶ m) versus distance in centimeters (10⁻³ m) in air from the ionizing source. This is well known to those skilled in the art as a Bragg curve for heavy ionizing Particles, in this example, alpha particles traveling in air. Alpha particles are one form of ionizing particle, and their range in air is dependent upon their initial energy in eV (Electron Volts). For an ionizing source such as Americium-241; a commonly used ionizing source in typical commercial ionization type smoke detectors; the distance in air for the alpha particle is approximately four centimeters, with the greatest ion pair production occurring around three-and-a-half centimeters. This occurs because in the case of alpha particles, the initial velocity through the air is highest, with the velocity slowing as the alpha particle interacts with more and more ambient air molecules. Near the end of the alpha particles track through air, when the alpha particle is moving more slowly, the time of interaction between the alpha particle and ambient air molecules is greatest, and therefore, more ion pairs per unit distance are created. The initial energy for an alpha particle from Americium-241 is around 5.5 MeV (Million Electron Volts). The quantity of ion pairs produced is proportional to the ionization current produced within the sample ionization chamber. Going back to the similarity to ionization type smoke detectors, we find that one of the early problems with designing an efficient ionization chamber for an ionization type smoke detector is dealing with the distance where the ionization source produces the greatest number of ion pairs per micron, and making a more attractive, low profile design smoke detector. One of the limiting factors in how thin an ionization type smoke detector can be made is the height of the ionization chamber. If one is designing an ionization type smoke detector, the amount of ionization current should be maximized so as to provide an ample amount of headroom between the “normal” smoke-free value of ionization current, and the lower alarm threshold value of ionization current. If there is only a small difference between the maximum “normal” value of ionization current and the lower alarm threshold value of ionization current, problems with false alarms could result. If the ionization chamber is made physically smaller than four centimeters (the maximum distance that an alpha particle of Americium-241 would travel in air), then the maximum ion pair generation per micron is never utilized, since the alpha particle would make contact with the wall of the ionization chamber before producing the greater quantity of ions per unit distance and the resulting ionization current produced within the ionization chamber (typically several picoamps) will be less than its potential maximum would be if the ionization chamber were four centimeters long. Additionally, other “less energetic” alpha sources could be utilized, such as Gadolinium-148 (Gd-148). If one wishes to keep the same Am-241 source, it could still be used if it is coated with a very thin (micron layer) coating of gold to reduce the initial energy of the alpha particle. By reducing the initial energy of the Am-241 source by forcing the alpha particles to pass through a thin layer of gold, the maximum ion pair production could now be utilized since the peak of the Bragg curve would now occur at a distance much less than three-and-a-half centimeters, preferably at a distance that is just shorter than the new height of the lower profile ionization chamber. The initial energy for an alpha particle emitted from Gd-148 (3.18 MeV) is much lower than that of Am-241 (5.5 MeV), and therefore the distance traveled in air for the Gd-148 alpha particle is less than it is for Am-241 alpha particles. If a lower profile ionization chamber is utilized, the Gd-148 could take advantage of the greater ion pair production per micron, and produce a greater ionization current than the more energetic Am-241 would produce for the same ionization chamber volume. This might initially sound counter-intuitive, but when examining the Bragg curve from FIG. 7, it makes much more sense. Although this patent does not concern itself with producing an effective low-profile ionization type smoke detector, it does endeavour to create the most sensitive ionization chamber for detecting airborne radioactive particles. If a terrorist were to make a dirty bomb, odds are that the radioactive material used would be whatever the terrorists could easily get hold of. This means that “pure” or homogenous forms of radioactive powder will most likely not be utilized. If a heterogeneous mix of radioactive material that contains different radioactive isotopes, with each emitting different initial energies of alpha particles, low energy and high energy alpha particles will make up the radioactive aerosol and the ionization chamber should be constructed so as to produce the greatest amount of ionization current with a minimum amount of radioactive particles inside. Typical “low profile” ionization type smoke detectors have hollow cylindrical ionization chambers on the size range of two-and-a-half centimeters in height. There is no reason to modify the internal structure of commercially made ionization type smoke detectors, other than simply removing the permanent source of ionizing radiation to carry out the task of the described invention. The beauty of keeping the internal structure of the ionization chamber similar to that of a typical ionization type smoke detector is that those that manufacturer ionization type smoke detectors, can quickly produce mass quantities of radioactive particle detectors with only minimal changes. The preferred embodiment of the disclosed invention utilizes a slightly longer ionization chamber (both reference and sensing ionization chambers) than is used in making low-profile ionization type smoke detectors. By utilizing a slightly longer ionization chamber, a radioactive particle detector could be constructed that will produce a greater amount of ionization current with the introduction of a heterogeneous mix of radioactive particles, since different radioactive isotopes will produce different alpha particles with greater or lesser energies. It is important to note that the basic construction utilized to produce contemporary low-profile ionization type smoke detectors will also perform the basic function of determining the presence of airborne radioactive particles—the only difference is that no permanent source of ionizing radiation will be utilized within the ionization chamber. The reason for discussing alpha radiation in more depth than beta, gamma, or x-ray radiation is that alpha radiation is impossible to detect at any significant distance from the source, since alpha radiation travels only a few centimeters in air. If radioactive particles are aerosolized that emit primarily alpha radiation, the result is that a typical radiation sensor could be just a few inches away from the alpha source and never detect any radioactivity. If a terrorist were to release a radioactive aerosol into the air, the problem in detection would be that unless a person were holding a radiation sensor just a few centimeters from the source, it would never be detected. With the described invention, an ionization chamber similar in construction to those used in contemporary ionization type smoke detectors (excluding the permanent source of ionizing radiation) would have little difficulty detecting particles that emit alpha radiation. It is true that alpha radiation can be stopped by the epidermis of the skin, or a single sheet of ordinary paper, and they pose no threat to people if kept external to the body, but if released into the air as an aerosol, they could be breathed into the lungs, ingested, or find their way into any open wounds or cuts. The epidermis of the skin is enough to shield the dermis from any potential damage from alpha particles; however, if radioactive particles that emit alpha radiation are inhaled, ingested, or make their way into open wounds or cuts, serious damage will result to the person. The described invention utilizes a cylindrical ionization chamber similar in construction to contemporary ionization chambers found in ionization type smoke detectors, with the only difference being that no permanent source of ionizing radiation is utilized. The ionization chamber enables the detection of alpha, beta, gamma, and x-ray radiation, by producing ion pairs from neutral air molecules within the ionization chamber brought about by introduction of radioactive particles within the ionization chamber.

To avoid confusion, it is important to differentiate between ions of air molecules produced inside the ionization chambers and atmospheric ions. Both are ions in the sense that they are no longer neutral, but the difference in the context of this patent is where the ions are produced. The atmospheric ions are produced external to the ionization chambers of the RADOSE sensor, and will be produced whether or not any radioactive particles are present. It is obvious to those skilled in the art that radioactive particles will certainly produce atmospheric ions, but atmospheric ions will be distinguished between those that are produced within the RADOSE sensors ionization sensors by interaction of radioactive particles. A passing thunderstorm could produce transient amounts of great quantities of atmospheric ions that could be introduced into the ionization chambers without any exposure to radioactive particles or radiological particles. Since the preferred embodiment of the described invention utilizes dual ionization chambers, transient events like thunderstorms will not produce false alarms since both ionization chambers will be equally affected, and the difference between them being zero. Ion pairs of air that are produced within the RADOSE sensors ionization chambers, specifically, the sample ionization chamber, are produced by interaction of neutral air molecules with the ionizing radiation emitted by radioactive particles.

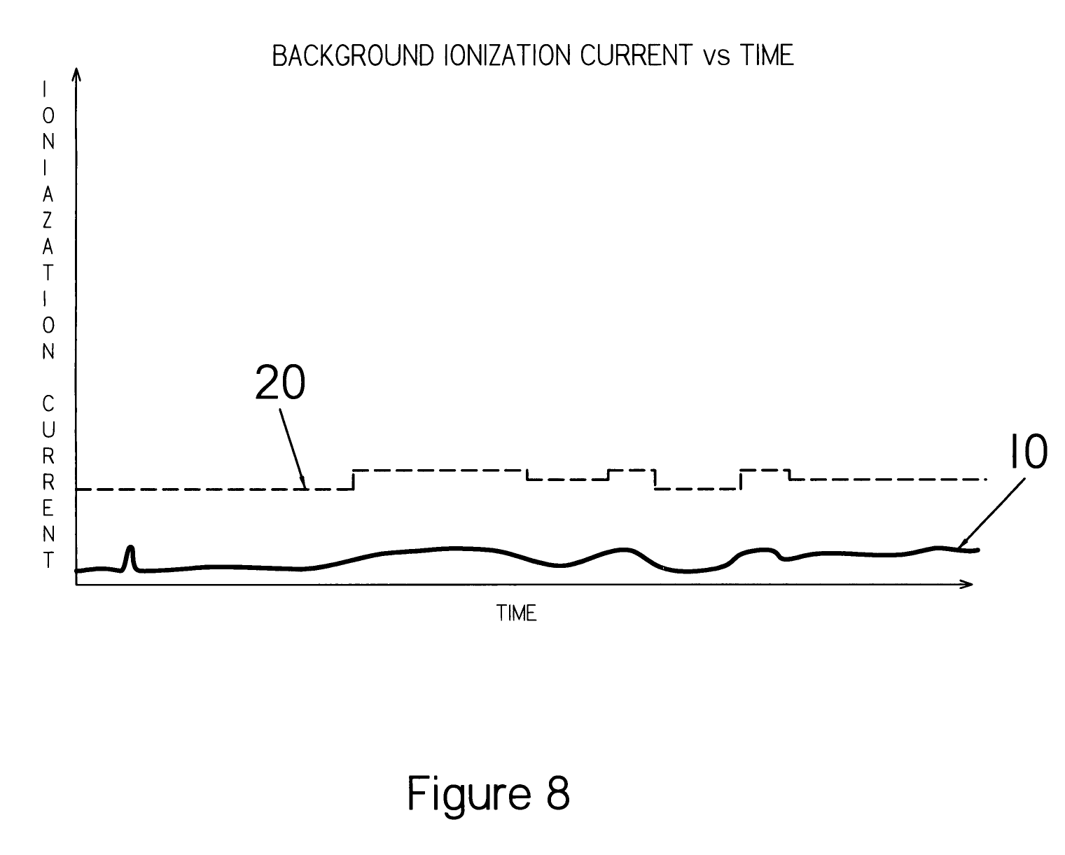

FIG. 8 shows a plot that illustrates a typical ionization current 10 produced within the RADOSE sensors reference ionization chamber or sample ionization chamber over time. The ionization current 10 will fluctuate to higher or lower values over time due to various background atmospheric conditions. Atmospheric ions can fluctuate throughout the day, throughout the seasons, and even increase to temporary abnormally high values due to a passing thunderstorm. Each of the RADOSE sensors ionization chambers (reference and sampling ionization chamber) will be affected by background atmospheric ions that find their way into the RADOSE sensors ionization chambers, and thus will produce a corresponding fluctuation in background ionization current 10. To allow for greater sensitivity, an algorithm could be utilized to determine the long-term background ionization current average, and calculate a suitable alarm threshold value 20. The alarm threshold value 20 can accurately track the slow long-term fluctuations of the background ionization current 10 and set an ionization current alarm threshold, where any value above this alarm threshold will cause an alarm indication. The alarm indication could be built into the RADOSE sensor itself, such as a loud buzzer, bright light, strobe, or the alarm indication could be a unique signal silently sent to a remote panel. Because the alarm threshold value 20 dynamically tracks the slow long-term fluctuations of background ionization current 10, there must be a time constant associated with it. If the time constant is too short, then any alarm condition could potentially be ignored as just a fluctuation. With a suitable time constant chosen, short-term, transient events in background ionization current 10 will be ignored, while long term trends will be tracked. A static threshold for alarm level could be utilized, but in the preferred embodiment of the disclosed invention, a dynamic alarm threshold value 20 will be utilized. The algorithm could be processed inside the RADOSE sensor by integrated electronics, or the background ionization current value could be periodically reported to a remote panel, and the processing done remotely by the panel. In the preferred embodiment of the disclosed invention, the alarm threshold value determination algorithm will be processed within integrated electronics of the RADOSE sensor itself.

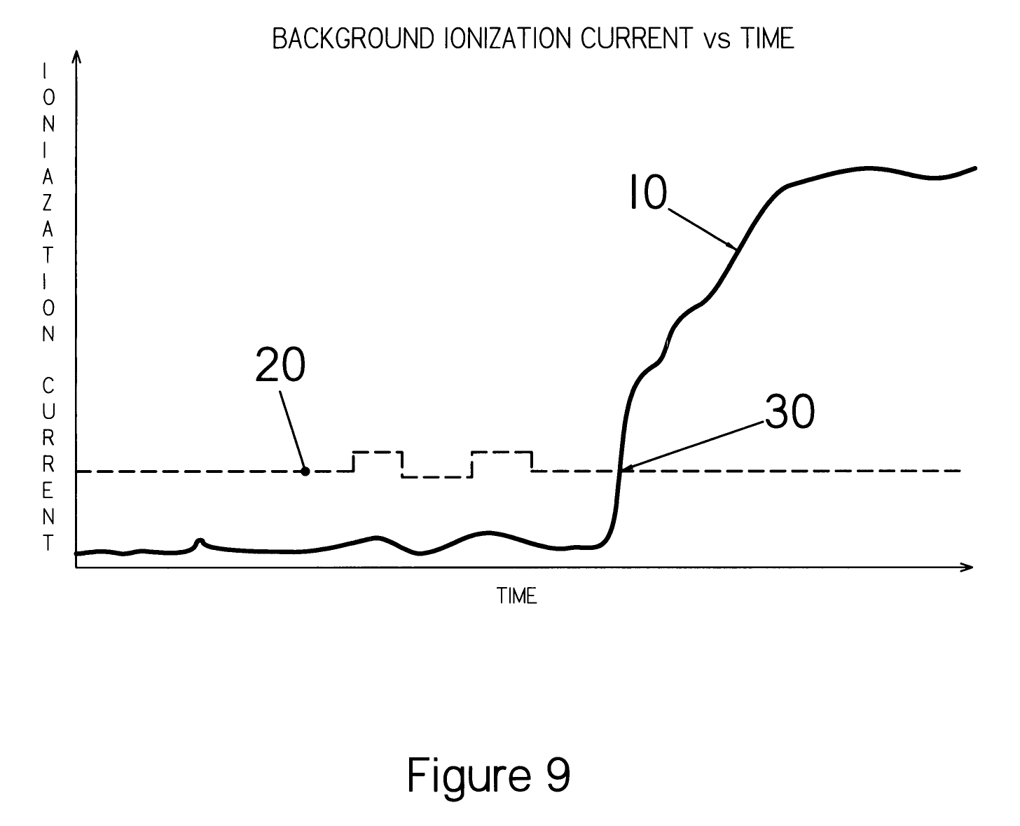

FIG. 9 shows a plot that illustrates ionization current 10 produced within the sample chamber ionization chamber over time. Just like the reference ionization chambers ionization current, the sample ionization chambers ionization current 10 will fluctuate to higher or lower values over time due to various background atmospheric conditions; however, the potential maximum magnitude of ionization current produced from the sample ionization chamber would be much greater than the maximum potential magnitude of ionization current produced by the reference ionization chamber, due to the presence of radioactive particles that can only enter the sample ionization chamber. Atmospheric ions can fluctuate throughout the day, throughout the year, and even increase to temporary abnormally high values due to a passing thunderstorm. Each ionization chamber (reference and sampling ionizing chamber) will be affected by background atmospheric ions, and thus will produce a corresponding fluctuation in background ionization current 10; however, only the sampling ionization chamber will respond to any large (micron sized) airborne radioactive particles. If any radioactive particles find their way into the sampling ionization chamber, a sharp and rapid increase in ionization current will be indicated in the sampling chambers ionization current. To allow for greater sensitivity, a dynamic algorithm could be utilized to determine the long-term background ionization current average, and determine an alarm threshold value 20. The alarm threshold value 20 can accurately track the fluctuations of the background ionization current 10 and set an ionization current alarm threshold, where any value above this threshold will cause an alarm indication. The alarm indication could be built into the RADOSE sensor itself, such as a loud buzzer, bright light, strobe, or the alarm indication could be a unique silent signal sent to a remote panel. Because the alarm threshold value 20 tracks the fluctuations of the background ionization current 10, there must be a time constant associated with it. If the time constant is too short, then any alarm condition could be ignored. Short-term transient events in background ionization current 10 will be ignored, while long-term trends will be tracked. A sudden increase in background ionization current 10 will cause the alarm threshold value 20 to no longer track the background ionization current 10 and will cause an alarm condition to be indicated once the background ionization current 10 crosses 30 the alarm threshold value 20. A static threshold for alarm level could also be utilized, but in the preferred embodiment of the disclosed invention, a dynamic alarm threshold value 20 will be utilized. The algorithm could be processed inside the RADOSE sensor by integrated electronics, or the background ionization current value could be periodically reported to a remote panel, and the processing done in the panel. In the preferred embodiment of the disclosed invention, the alarm threshold value determination algorithm will be processed within integrated electronics of the RADOSE sensor.

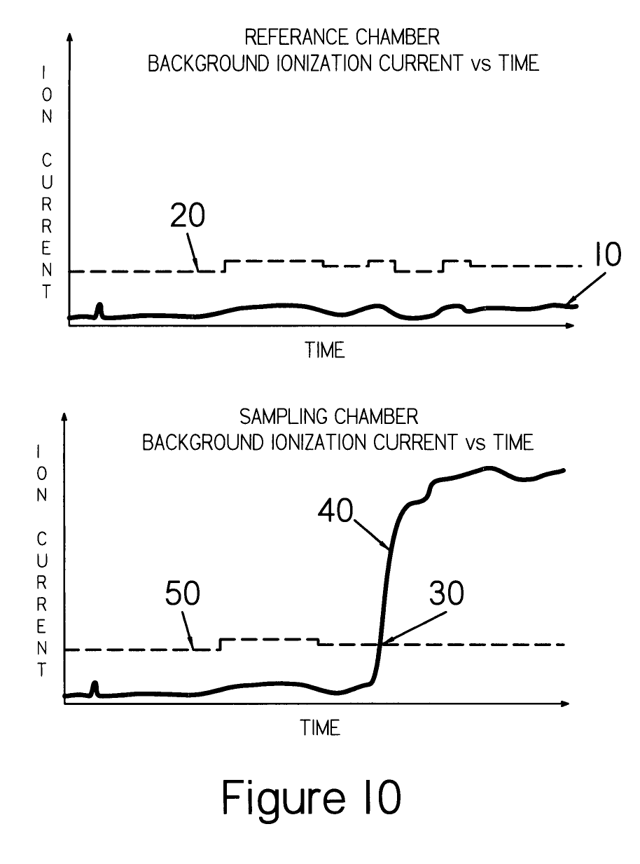

FIG. 10 shows two plots, the upper plot illustrates ionization current 10 produced within the reference ionization chamber over time, while the lower plot illustrates ionization current 40 produced within the sampling ionization chamber over a similar time period. The ionization current for both the reference ionization chamber 10 and the sampling ionization chamber 40 will fluctuate to higher or lower values over time due to various background atmospheric conditions. Atmospheric ions can fluctuate throughout the day, throughout the year, and even increase to temporary abnormally high values due to a passing thunderstorm. Each of the RADOSE sensors ionization chambers (reference and sampling ionization chamber) will be affected by background atmospheric ions, and thus will produce a corresponding fluctuation in background ionization current; however, only the sampling chamber will respond to any airborne radioactive particles indicative of a “dirty bomb” or radioactive aerosol. If any radioactive particles find their way into the RADOSE sensors sampling ionization chamber, a sharp increase in ionization current will be indicated in the sampling chambers ionization current 40. To allow for greater sensitivity, an algorithm could be utilized to determine the long-term background ionization current average, and determine an alarm threshold value for both the reference ionization chamber 20 and the sampling ionization chamber 50. The alarm threshold value can accurately track the fluctuations of the background ionization current and set an ionization current threshold, where any value of ionization current above this threshold will cause an alarm indication. The alarm indication could be built into the RADOSE sensor itself, such as a loud buzzer, bright light, strobe, or the alarm indication could be a unique silent signal sent to a remote panel. Because the alarm threshold value tracks the fluctuations of the background ionization current, there must be a time constant associated with it. If the time constant is too short, then any alarm condition could be ignored. Short-term transient events in background ionization current will be ignored, while long-term trends will be tracked. A rapid increase in the sampling ionization chamber background ionization current 40 will cause the alarm threshold value 50 to no longer track the sampling ionization chamber background ionization current 40 and will cause an alarm condition to be indicated once the sampling ionization chamber background ionization current 40 crosses 30 the alarm threshold value 50. A static threshold for alarm level could be utilized, but in the preferred embodiment of the disclosed invention, a dynamic alarm threshold value will be utilized. The algorithm could be processed inside the RADOSE sensor by integrated electronics, or the background ionization current value could be periodically reported to a remote panel, and the processing done in the panel. In the preferred embodiment of the disclosed invention, the alarm threshold value determination algorithm will be processed within integrated electronics of the RADOSE sensor.

The presence of atmospheric ions can be brought about by several means, such as fires, electrical equipment, the interaction of cosmic rays with the atmosphere, thunderstorms, ionizing radiation, and ultraviolet light. The preferred embodiment of the described invention utilizes a dual ionization chamber design without any permanent source of ionizing radiation, but it is obvious to those skilled in the art that a single ionization chamber design can also be utilized, although its operation will be much more prone to false alarms. A problem to overcome is the background determination and compensation of atmospheric ions. The same type of algorithm that is utilized to determine a “normal” background (smoke free) value in a commercial ionization type smoke detector can be utilized in both the dual and single ionization chamber RADOSE sensor to determine the normal background amount of atmospheric ions. The value of what can be considered a “normal background” of ionization current will most likely be unique to each individual RADOSE sensor, and even to each individual ionization chamber, and to some extent the physical placement. The value of “normal background” of ionization current can be established over a period of time, with any rapid increase of ionization current producing an alarm. A small electric fan can be incorporated into the RADOSE detector housing to facilitate faster response by pulling in ambient air. The fan does not have to operate in a continuous manner, but can be pulsed on and off to reduce power consumption and increase battery life (if powered by a battery). The RADOSE can also serve as a Radon gas detector if the sampling ionization chamber is temporarily closed off (for a period of several hours to up to four days). The RADOSE sensor can also be placed in a suitable enclosure to allow it to function in a forced hot air or air conditioning system. This will allow the RAOSE to monitor a much larger volume of air. Radon has the ability to ionize air by emitting alpha particles, (although not all isotopes of Radon decay by alpha decay) and can be detected by utilizing an ionization chamber such as the type similar in construction to those used in ionization type smoke detectors and described in this patent. The detection of radon gas would be accomplished by detecting the gradual buildup of ionization current within the reference ionization chamber. Radon, element 86, is the heaviest of the noble gases with many (at least thirty-six known) isotopes of widely ranging half-life's, with the majority of radioactive decay by means of alpha decay. There are no stable isotopes of Radon, with half-lifes ranging from less than a micro-second (10⁻⁶ seconds) to several days. Radon-214 (Rn-214) has the shortest half-life of approximately 0.27 micro-seconds, while Radon-222 (Rn-222), the most stable isotope, has the longest half-life of approximately 3.82 days. All isotopes other than Rn-222 do not have a long enough half-life to cause concern. Radon-222 (Rn-222) is a natural decay product of Uranium-238 (U-238). Areas of the country in which the soil contains high concentrations of Uranium or Thorium can also have high amounts of Radon. The national exposure limit to Radon gas is currently set to 4 pCi/L of air—four Pico-Curies (10⁻¹² Curies) of activity per liter of air. A Curie (Ci) is a unit of activity named for the framed Nobel Prize winning Polish scientist Marie Curie who pioneered the field of radioactivity, and is equivalent to 3.7×10¹⁰ disintegrations per second. It is obvious that a Curie (Ci) is an extremely large number, and when dealing with things like the radioactive sources in ionization type smoke detectors, the amount of activity is roughly one-millionth of a Curie. Typical activity levels for radioactive sources used in ionization type smoke detectors are commonly equal to or less than 1 μCi (10⁻⁶ Curie), or 37,000 disintegrations per second. When talking about Radon, the maximum exposure level of activity is in the Pico-Curie (pCi) range, specifically 4 pCi (0.148 disintegrations per second). This small amount is set as the national exposure limit, and is equivalent to roughly one disintegration every seven seconds. This low level of activity may not sound like much, but Radon is the second leading cause of lung cancer in the United States, only exceeded by cigarette smoking.

A commercially available ionization type smoke detector typically measures ionization current in the picoamp (10⁻¹² Amps) region. The described invention utilizes technology and manufacturing methods that are virtually identical to proven manufacturing techniques for commercially available ionization type smoke detectors. By continually sampling the clean background value of ionization current (no radioactive particles present in the ionization chambers), a value of alarm threshold can be set to a much higher value than would be anticipated from the result of atmospheric ions alone, but low enough to allow for a high sensitivity to the presence of radioactive particles. This would be extremely important in the case of single ionization chamber construction. Thunderstorms can cause a temporarily major increase in the amount of atmospheric ions. In the preferred embodiment of the described invention, the RADOSE sensor will be constructed with dual ionization chambers. An internal “self test” method will be utilized to test the normal operation of the RADOSE sensor unit by temporarily closing off either the reference ionization chamber or the sample ionization chamber, and measuring the small value of ionization current produced. It does not matter which ionization chamber is closed off, because we are measuring the difference between the ionization chambers ionization current with exposure to ambient air, and when it is closed off from ambient air. Each ionization chamber could be tested individually, or a difference could be noted between one ionization chamber open to ambient air, while the other is closed off from ambient air. There are several methods for a valid internal “self test” for the RADOSE sensor. In the preferred embodiment of the disclosed invention, the sampling ionization chamber will be temporarily closed off. After the internal “self test” is over, the temporarily closed off ionization chamber is once again exposed to the ambient air for normal operation. The internal “self test” will indicate a fail condition, if during the period of time (several seconds to several minutes) when the sample ionization chamber is off closed to the ambient air; no measurable difference in background ionization current is measured between the ionization current value when opened to ambient air, and closed off to ambient air. If a difference in ionization current is measured during this test, the result is a successful internal “self test”, and the test condition is considered a “pass”. Three individual internal “self tests” could be performed, a sample ionization chamber self test, a reference ionization chamber self test, and a chamber to chamber self test. In the first case, where a sample ionization chamber self test is performed, the process involves temporarily closing off the sample ionization chamber from ambient air, recording the value of ionization current while closed off from ambient air, and comparing this value from a value of ionization current taken before the sample ionization chamber was closed off from ambient air. In the second case, where a reference ionization chamber self test is performed, the process involves temporarily closing off the reference ionization chamber from ambient air, recording the value of ionization current while closed off from ambient air, and comparing this value from a value of ionization current taken before the reference ionization chamber was closed off from ambient air. In the third case, one of the ionization chambers is temporarily closing off from ambient air while the other ionization chamber is left alone. The difference between each of the ionization chambers ionization current is measured and compared with a recorded value of the ionization current difference between the two ionization chambers taken when both ionization chambers were each exposed to ambient air. If no difference is noted between each of the two values, then the self test is considered a “fail”. In addition to internal self tests, an external self test could also be performed by placing a commercially available radioactive source next to the RADOSE sensors sample ionization chambers openings. An alpha radiation source, such as Polonium 210 could be utilized, by placing the source in the immediate proximity of one of the openings of the sample ionization chamber. On detection of the Polonium source, an alarm would be triggered by the RADOSE sensor. It should be obvious to those skilled in the art that Polonium 210 has a short usable period serving as an external test source considering its relatively short half-life. Polonium 210 has a half-life of approximately 138 days, and would have to be replaced quite often.

As stated previously, one of the great benefits of the disclosed invention is that manufacturers who have manufactured ionization type smoke detectors for decades, can now produce a nearly identical unit that contains absolutely no radioactive material at all, and can be used in a new a novel way as a radioactive particle, radiation, and radon detector. If the RADOSE is constructed in a similar manner to a commercially available addressable intelligent ionization type smoke detector, the RADOSE can operate in a similar manner, and send back real-time information as to the magnitude of the ionization current. In this way, the fire or security panel software could determine the normal background reading and utilize suitable sensitivity algorithms to reduce the possibility of false alarms.

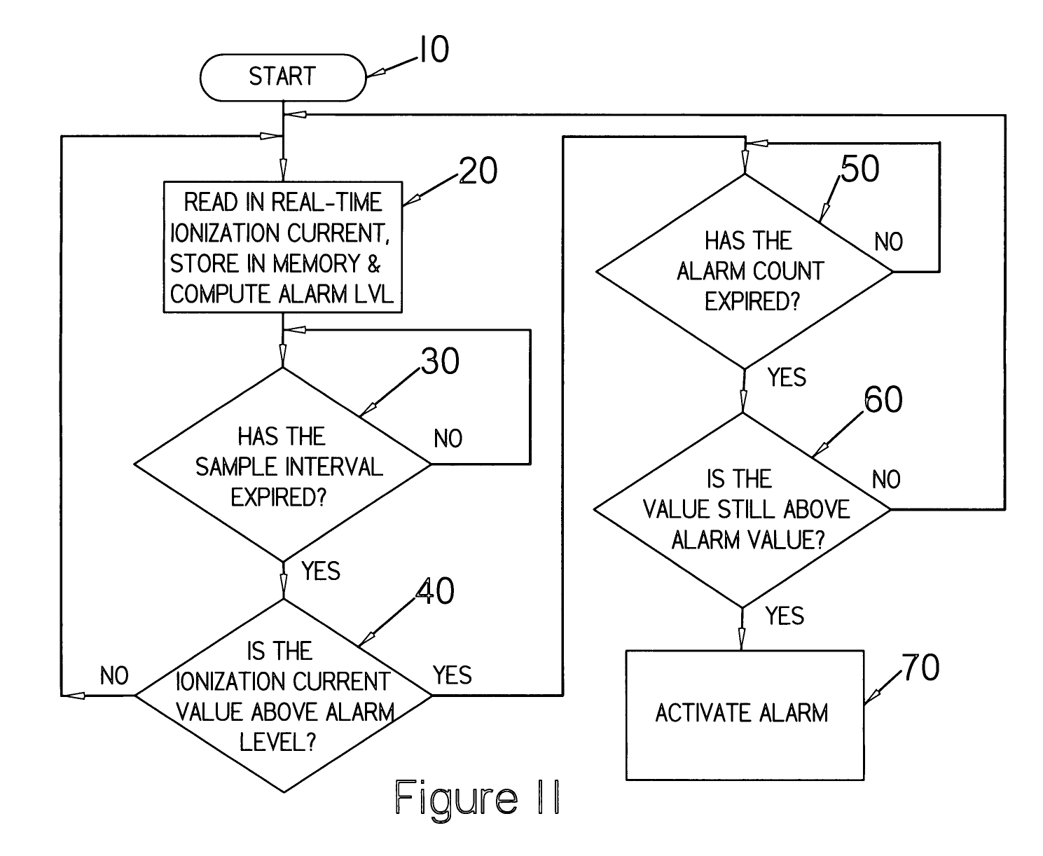

FIG. 11 describes an algorithm that could be utilized to establish a baseline background ionization current level, and also determine a situation in which an alarm would be indicated. The RADOSE is initially started 10 either after a reset or on power-up. After the initial start 10, the RADOSE reads the values corresponding to the ionization current 20 by an A/D (Analog to Digital) or another applicable conversion technique. The value of ionization current read in is stored in memory (either within the RADOSE sensor or external to the RADOSE sensor). After a few values of ionization current are read and recorded, an average value is calculated to form the basis of a baseline background ionization current level. On the initial first time startup of the RADOSE, an accurate baseline may not have been calculated so it would be prudent to temporarily ignore any alarm conditions for a short time period of approximately one minute for a portable unit, or five to ten minutes for a permanent affixed unit. When a baseline average has been calculated from a series of ionization current values, an alarm threshold level can be calculated from this. For greatest sensitivity, a value close to the baseline background ionization current level is preferred, but for practical reasons (preventing false alarms and nuisance alarms), a threshold value of several times higher would be utilized. If the baseline background ionization current level is fairly low (less than a picoamp (10⁻¹² Amp)), then a low alarm threshold could be utilized. The alarm threshold is dependent upon the value of calculated baseline background ionization current level and will be unique to each individual RADOSE sensor.

The baseline background ionization current level is read in or sampled frequently by utilizing a timer 30 that continually times out and resets. A typical timer duration would be from one to sixty seconds. This means that a value for the ionization current level is read in every time the timer counts down. In the preferred embodiment of the disclosed invention, the timer duration would be five seconds, enabling twelve samples of the ionization current to be read in every minute. On initial startup of the RADOSE unit, a timer interval of less than five seconds would be utilized to allow for a quick but course determination of a baseline background ionization current level. In the preferred embodiment of the described invention, the initial startup timer duration would be one second, enabling sixty of the ionization current to be read in every minute. After two or three minutes, the RADOSE would switch back to a timer duration of five seconds. This allows a quick establishing of an appropriate alarm threshold level. After the initial alarm threshold level is calculated, a comparison is made between the stored value of the alarm threshold and the measured ionization current level 40. If the measured ionization current level is found to be equal to or greater than the alarm threshold level, then a check is made to determine if this is a transient or stable value of ionization current 50. A transient value of ionization current should not be treated as a full-fledged alarm, and should be sampled several times to determine if it is a valid alarm condition. If the measured value of ionization current exceeds the alarm threshold for only a brief instant of time, then it should not be treated as an alarm, but only as a transient event with no alarm indicated. The alarm should be treated as an alarm if, and only if the measured ionization current value is equal to or greater than the alarm threshold for several samples. In the preferred embodiment of the described invention, the alarm count would be equal to at least four samples. This means that if the measured ionization current value is equal to or greater than the alarm threshold for four sample intervals, then an alarm should sounded. In the preferred embodiment of the described invention, the value of alarm count, that is, the number of timer intervals that the measured ionization current must be equal to or greater than the alarm threshold, could be modified by the user, with an adjustable range from an alarm count of one to sixty timer intervals, but not limited to a maximum of sixty timer intervals. This enables the RADOSE sensor to perform an alarm verification protocol. If after the alarm count has been reached the ionization current is still equal to or greater than the alarm threshold value 60 an alarm should be indicated 70. An alarm could be indicated internal to the RADOSE (if the RADOSE is operated as a standalone device) sensor by activating a buzzer, sounder, light, or strobe, or it could additionally send an alarm signal to a remote panel. The alarm signal to a remote panel could be accomplished several ways; a simple contact closure from a relay, a coded or un-coded signal sent from a wireless transmitter, such as a cell phone connected to or built into the RADOSE unit, a coded or un-coded signal sent from a modem that interfaces the RADOSE sensor to a phone line, a coded or un-coded signal sent from an rf transmitter other than a cell phone, such as a dedicated wireless transmitter, a wireless link to a wireless network, such as a WiFi, or a connection to a network.

If the alarm signal is accomplished by contact closure from a relay, then virtually any contemporary security and/or fire protection service could monitor this. Typical contemporary security and/or fire protection services include institutions such as ADT or Brinks Home Security. Security and/or fire monitoring services usually have designed into their infrastructure, an input for a “third party” security or smoke/fire detection devices. The activation of this is usually accomplished by a contact closure from a device external to the contemporary security and/or fire protection service infrastructure. The “third party” input, once activated by a contact closure from a relay built into the RADOSE sensor would alert the contemporary security and/or fire protection service of a radiological event, such as the detection of an aerosol of radioactive particles.

If the alarm signal is accomplished by a signal sent from a wireless rf (radio frequency) transmitter, a corresponding remote wireless rf receiver would have to be included. The wireless rf receiver would be connected to a device such as dedicated electronics that will cause an alarm to be indicated on its panel when the expected alarm signal is sent from the RADOSE sensors rf transmitter. The wireless rf transmitter could be a dedicated wireless rf transmitter or transceiver (able to both send and receive information), or it could be a cell phone that is programmed to dial a specific phone number in the event an alarm condition is transmitted from the RADOSE sensor. It is obvious to those skilled in the art that the rf signal sent from the wireless transmitter or transceiver could be either coded or un-coded, or even encrypted in instances where higher levels of security are needed, such as for homeland security, government, military, or law enforcement use. The cell phone could be an external device connected to the RADOSE sensor or it could be built into the RADOSE sensor as an integral part of the RADOSE system. It is obvious to those skilled in the art that a wireless signal could be sent not only by rf (radio frequency), but also by optical means, such as light. If light is used to convey the alarm information from the RADOSE sensor unit, the preferred method would be to utilize invisible portions of the spectrum, such as infrared light to reduce the possibility of interference from local sources. The wireless signal could also be sent to a wireless network such as a WiFi. The signal sent to a WiFi could help to map individual RADOSE sensor detectors to a central monitoring service to aid local first responders and emergency workers to determine the source and area affected by a aerosol of radioactive particles, and also help to track the progress of a release of an aerosol of radioactive particles.

If the alarm signal is accomplished by a signal sent from a hard wired device such as a modem connected to a phone line, then a specific number could be called report the alarm condition to a centralized monitoring service (such as ADT or Brinks Home Security). When the alarm signal is sent from the RADOSE sensor, the centralized monitoring agency would be able to plot the location of the aerosol of radioactive particles, and help local authorities, and first responders to investigate the affected areas. A map of alarms sent from a series of widely distributed RADOSE sensors would allow a centralized monitoring agency to generate a plot that would indicate areas that could be contaminated with radioactive particles, and also to help determine a central release point or points if multiple releases are brought about. A signal sent from a modem could also allow the RADOSE sensor to access the Internet and World Wide Web, that would allow information to be accessible to virtually anywhere in the world to be utilized by agencies throughout the world to help combat deliberate acts of terrorism or assist first responders by tracking aerosols of radioactive particles from accidental release, such as the infamous Chernobyl nuclear disaster that occurred on April of 1986. No one truly knows the extent of the radioactive material that was released as an aerosol of radioactive particles because there was not an adequate quantity of instrumentation put in place to monitor it. A series of RADOSE sensors widely distributed throughout large areas would enable accurate, rapid, near real-time monitoring of intentional or accidental releases of radioactive particles.

A remote panel is considered anything external to the RADOSE sensor that has the ability to reliably communicate with the RADOSE sensor in either a simplex or full duplex operation. The remote panel would have the ability to either just listen for transmissions from a RADOSE sensor (as in simplex operation) or the remote panel can talk (send commands and query's) to the RADOSE sensor as well as listen to (receive information) the RADOSE sensor. The remote panel should contain suitable electronics that would respond to un-coded, coded, unencrypted, or encrypted signals received from the RADOSE sensor unit to initiate an alarm that can produce an audible, visual, or audible and visual warning that an alarm condition has been detected by a monitored RADOSE sensor unit. Audible alarms are in the form of buzzers, sounders, or audible messages announced form a RADOSE sensor itself, or through a public address (PA) system, while visual alarms are in the form of lamps, lights, strobes, or flashing lights to indicate an alarm. The RADOSE sensor unit could also produce an alarm integral to itself, if the RADOSE is utilized as a portable radioactive particle sensor or permanent, fixed, standalone unit. In addition, a text message could be sent to a pre-determined cell phone.

If the RADOSE sensor is utilized as a portable sensor, it will be battery powered, and also have the option of utilizing a GPS (Global Positioning Sensor) to indicate the exact coordinates of the RADOSE when an alarm is indicated. The GPS sensor could be a dedicated GPS circuit board that is connected either internal or external to the RADOSE sensor unit, or it could be a cell phone with GPS capability. Either way, the GPS information will be provided along with the alarm signal from an individual or plurality of RADOSE sensor units. A cell phone equipped with a GPS sensor would monitor a connected RADOSE sensor unit for an alarm signal, and upon reception of an alarm signal from the RADOSE sensor unit, the cell phone will “call” a specific number of a responsible monitoring agency, and report that a RADOSE sensor unit has detected a quantity of radioactive particles that produce an ionization chamber current that is equal to or greater than its alarm ionization current level threshold, along with the exact GPS coordinates of the RADOSE. The cell phone circuitry could be built directly into the RADOSE sensor unit and transmit information to a remote location. If the information is sent to a remote location, either wired or wireless, then each RADOSE sensor unit will contain a unique identification. The unique identification can be in the form of a unique electronic serial number and/or a user settable address that could be mapped to a specific location or area that the RADOSE sensor unit is monitoring. A plurality of RADOSE sensor units could be permanently installed inside a building and connected to the buildings fire or security infrastructure. The connection can be a physical, fiber-optic or wired connection directly to the fire or security infrastructure, or a wireless optical or rf connection.

As stated earlier in this patent, several methods for indicating an alarm condition when the RADOSE sensor unit is connected to a buildings fire or security infrastructure could be utilized. If the RADOSE is connected to a building firepanel infrastructure, by modifying the fire or security infrastructure software, a new and enhanced ability is given to fire or security systems to enable them to help combat terrorist threats and to increase the safety and security of building occupants. With the issue of homeland security in the spotlight, this is a simple and effective means that with minimal investment will help protect people from harm due to the deliberate attack by a terrorist group due to the explosion of a “dirty bomb”, or a deliberate or accidental release of radioactive particles.

The RADOSE can be manufactured to function with commercial fire alarm or security systems or as standalone units suitable for installation in commercial or residential dwellings. The RADOSE can function to detect for the presence of radioactive particles or radiation. In the preferred embodiment of the disclosed invention, the RADOSE sensor will be constructed with dual ionization chambers—a reference chamber (non-active chamber) and a sampling chamber (active chamber). Each ionization chamber (reference chamber and sampling chamber) will be constructed nearly identical to those used in contemporary commercial and residential ionization type smoke detectors with the exception that the permanent source of ionizing radiation is not utilized. The ionization current from each ionization chamber will be subtracted and taken as a difference signal in normal particle detection operation. The magnitude of the ionization current from each ionization chamber as well as the rate of increase from each will be measured separately to determine for the presence of a strong source of ionizing radiation (ionizing particles), such as alpha, beta, gamma, and x-ray. If there were a sudden increase in the background ionization current from both ionization chambers in the RADOSE sensor, it is strongly possible that a strong source of ionizing radiation is within close proximity of the RADOSE sensor. Alpha radiation (ionizing particle) will only travel a few centimeters in air, so an alpha source of radiation (ionizing particle) must be within a few centimeters (<7 cm) distance from the RADOSE sensor to have any affect on the ionization chamber current. Beta, gamma, and x-ray ionizing radiation (ionizing particles) will travel much further in air, and also penetrate plastic and thin sheets of metal, such as the type used to construct a typical ionization chamber similar in construction to contemporary commercial and residential ionization type smoke detectors. To distinguish between radioactive particles within the ionization chambers and radioactive particles external to the ionization chamber, it would be required to shield the reference ionization chamber with a suitable ionizing particle shield such as a thin layer of lead. If the reference ionization chamber were shielded by a thin lead shield, then external radioactive particles that produce ionizing particles capable of penetrating the thin metal required to construct the ionization chambers, will not penetrate into the reference ionization chamber. Due to hazmat issues, weight, and the construction complexity of adding an ionizing particle shield to the reference ionization chamber, the preferred embodiment of the disclosed invention will not include a shield for the reference ionization chamber, but will allow for it to be included as an option. By measuring a simultaneous rapid increase in the reference ionization chambers current and the sample ionization chambers current, a unique radiation alarm could be generated that would indicate the presence of a strong ionizing source of radiation, and thus distinguish between a source of ionizing radiation or radioactive particles. The ionizing radiation would most likely affect both ionization chamber simultaneously, while radioactive particles would affect only the sampling ionization chamber (assuming that the reference ionization is suitably shielded), thus by monitoring the ionization current from both chambers, a distinction could be made between a source of ionizing radiation in close proximity to the RADOSE sensor and radioactive particles detected inside the sampling ionization chamber. Either way, an alarm indicating a close, strong source of ionizing radiation close to the RADOSE sensor unit or radioactive particles present within the sample ionization chamber of the RADOSE sensor unit are a cause for alarm to anyone within close proximity. The preferred embodiment of the disclosed invention will monitor the ionization current from each ionization chamber (reference and sampling chamber) individually, in the RADOSE sensor, and will also take the difference between the two ionization currents to compensate for atmospheric conditions that could cause a higher than “normal” ionization chamber current and thus cause a false alarm. If we use a similar methodology, but look for a slow, gradual buildup in magnitude of the ionization current from each ionization chamber (reference and sampling ionization chamber), then this will allow the RADOSE sensor to also detect for the presence of radioactive Radon gas. In addition, there are additional methods for the RADOSE to detect for the presence of Radon gas. One method is the temporarily close off the input pores of the sample ionization chamber in the RADOSE sensor and measure the ionization current from the reference ionization chamber. By closing off the entrance to the sampling ionization chamber (either manually or by an automated means), this guarantees that only a gas will be allowed to enter the RADOSE sensor unit, since the pores on the reference ionization chamber are too small to allow any large particles inside the reference ionization chamber. Since radon is a gas, only radon, or some other radioactive gas will cause a gradual buildup of ionization current within the reference ionization current since the pores of the reference ionization chamber will allow only gas and water vapor to penetrate, and will block any particles from penetrating. A typical measurement scenario to check for radioactive radon gas is to temporarily close off the sample ionization chamber, measure the reference ionization chambers background ionization current, and temporarily store this value, either internal to the RADOSE sensor unit or in a remote panel. A calculation can be done on the measured ionization chamber current values sampled from the reference ionization chamber to determine if any increase is noted, and determine if the area being monitored is exposed to a buildup of radon gas. The test would take an extended period of time (several hours to up to four days) to perform while the sample ionization chamber is closed off to the ambient air. This amount of time should allow enough samples to be taken from the reference ionization chambers ionization current to determine for the presence of radon. After the test is complete, the sample ionization chamber will be open once again to ambient air so it could perform its primary function as a radioactive particle detector.

It is preferable when trying to detect for the presence of Radon gas by monitoring each individual ionization chambers ionization current, and develop a “trend” over time. What is required to do this is to determine the normal background (clean baseline) ionization current for each ionization chamber separately. The exposure of the ionization chambers in the RADOSE sensor will be affected by atmospheric ions, such as those caused by fires, heat sources, the interaction of cosmic rays with the atmosphere, thunderstorms, ionizing radiation, Radon gas, and ultraviolet light. The rate of ionization current buildup in each ionization chamber, as well as the magnitude of the ionization current buildup will give key information as to determining whether a thunderstorm is passing through (short duration peaks), or if there is a continual exposure to Radon gas, or a strong source of ionizing radiation. This can only be differentiated if the magnitude and rate of increase are recorded. A passing thunderstorm can produce short duration, rapidly increasing high levels of measured ionization current in both ionization chambers, while continued exposure to areas affected by radon gas will show slow and gradual levels of measured ionization current in both ionization chambers. A strong source of ionizing radiation that is briefly brought in close proximity to a RADOSE sensor unit can produce rapid, high magnitude levels of measured ionization current in both ionization chambers, and can signify that a strong source of ionizing radiation has been in close proximity to one of the RADOSE sensor units. If radioactive particles are within the sampling chamber of the RADOSE sensor units sampling ionization chamber, the magnitude of ionization current will rapidly increase in magnitude in only the sampling ionization chamber, while the ionization current for the reference ionization chamber will be unaffected, since the radioactive particles cannot enter the reference ionization chamber.

A means of manual “self test” can be realized if an ionization source is placed in such a way as to ionize the neutral air molecules inside one or both of the RADOSE ionization chambers. Some methods of ionizing neutral air can be the application of a heat source (such as a heated filament) inside the ionization chambers, an ultraviolet light source, or a small conductive needle that is at a high electric potential. Because we are attempting to ionize air, the source in the case of an ultraviolet source would have to have a very short wavelength. The work function of air is approximately 34 eV, requiring a photon wavelength of approximately 36 nm (10⁻⁹ meters) to ionize the air. This wavelength is extremely difficult to attain economically with contemporary technology, and would be very difficult to place such a source inside the ionization chambers. The other methods would be much easier to employ, but would sacrifice battery life—assuming that the RADOSE sensor is powered solely by battery power, as in the case of a portable unit. The preferred embodiment of the described invention would utilize atmospheric ions as a means of internal “self test” as described earlier in this application. An external ionizing radiation source, such as are available from nuclear laboratories would likely be utilized for periodic manual testing. A Polonium 210 alpha source could be manually placed in close proximity to the openings of the sample ionization chamber. If there is a direct (line of sight) opening for the ionizing particles to pass into the sample ionization chamber, a rapid buildup of ionization current will be indicated, and a successful self test would be indicated. It would be prudent to enable a specific “manual self test” mode of operation, where an indication would be signaled to the person performing the test, while not activating any alarms that could potentially evacuate building and cause mass panic. Since an encapsulated alpha radiation source can be handled safely without extensive shielding, this would most likely be the best candidate for testing with actual ionizing radiation. An alpha source of polonium 210 or Americium-241 of suitable activity would provide rapid increases in the sample ionization chambers ionization current for testing purposes.

### REFERENCE NUMERALS

### FIG. 1:

10 DC Voltage source
20 Metal ionization chamber housing with positive connection to voltage source
30 Particle trail of ionizing radioactive source
40 Metal ionization chamber housing (smaller plate) with negative connection to voltage source
50 Ionizing radioactive source

### FIG. 2:

10 DC Voltage source
20 Metal ionization chamber housing with positive connection to voltage source
30 Positive ions of air created by interaction of ionizing radioactive source
40 Metal ionization chamber housing (smaller plate) with negative connection to voltage source
50 Ionizing radioactive source
60 Negative ions of air created by interaction of ionizing radioactive source

### FIG. 3:

10 DC Voltage source
20 Metal ionization chamber housing with positive connection to voltage source
30 Positive ions of air created by interaction of ionizing radioactive source
40 Metal ionization chamber housing (smaller plate) with negative connection to voltage source
50 Ionizing radioactive source
60 Negative ions of air created by interaction of ionizing radioactive source
70 Small particles of smoke/combustion particles

### FIG. 4:

10 DC Voltage source
20 Metal ionization chamber housing with positive connection to voltage source
30 Neutral molecule of air contained within the volume of the ionization chamber
40 Metal ionization chamber housing (smaller plate) with negative connection to voltage source

### FIG. 5:

10 DC Voltage source
20 Metal ionization chamber housing with positive connection to voltage source
30 Positive ions of air created by interaction of ionizing radioactive source
40 Metal ionization chamber housing (smaller plate) with negative connection to voltage source
50 Ionizing radioactive particle within the volume of the ionization chamber
60 Negative ions of air created by interaction of ionizing radioactive source

### FIG. 6:

10 DC Voltage source of reference chamber
20 Metal ionization chamber housing with positive connection to voltage source of the reference ionization chamber
30 Neutral air molecules contained within the volume of the reference ionization chamber
40 Metal ionization chamber housing (smaller plate) with negative connection to voltage source of the reference ionization chamber
50 Schematic representation of an ammeter to indicate magnitude of ionization current within the reference ionization chamber
60 Small pores that allow only air molecules and water vapor inside the reference ionization chamber while blocking all larger particulates
70 Small radioactive particles
80 DC Voltage source of sampling chamber
90 Metal ionization chamber housing with positive connection to voltage source of the sampling ionization chamber
100 Positive ions of air created by interaction of ionizing radioactive particles within the sampling ionization chamber
110 Negative ions of air created by interaction of ionizing radioactive particles within the sampling ionization chamber
120 Metal ionization chamber housing (smaller plate) with negative connection to voltage source of the sampling chamber
130 Schematic representation of an ammeter to indicate magnitude of ionization current within the sampling ionization chamber
140 Small radioactive particles
150 Large pores that allow air molecules and water vapor inside the sampling ionization chamber in addition to all larger particulates

### FIG. 7:

Plot that illustrates ion pair production of Americium-241 as a function of distance through air.

### FIG. 8:

10 Background ionization current plotted over increasing time.
20 Alarm threshold value of background ionization current.

### FIG. 9:

10 Background ionization current plotted over increasing time.
20 Alarm threshold value of background ionization current.
30 Point at which the background ionization current crosses the alarm threshold value.

### FIG. 10:

10 Reference chamber background ionization current plotted over increasing time.
20 Reference chamber alarm threshold value of background ionization current.
30 Point at which the sampling chamber background ionization current crosses the sampling chamber alarm threshold value.
40 Sampling chamber background ionization current plotted over increasing time.
50 Sampling chambers alarm threshold value of background ionization current.

### FIG. 11:

10 Flow chart symbol indicating the start of the logical decision process
20 Flow chart symbol showing a process block, where real-time ionization chamber current information is read in, stored, and mathematical calculations are performed on this data.
30 Flow chart symbol indicating a decision block to determine if the sample interval has expired.
40 Flow chart symbol indicating a decision block to determine if the sample read in from the ionization chamber current is equal to or greater than the calculated alarm threshold.
50 Flow chart symbol indicating a decision block to determine if several consecutive values (equal to value stored in the alarm count) of the sample from the ionization chamber value has been reached.
60 Flow chart symbol indicating a decision block to determine if the sample read in from the ionization chamber current is equal to or greater than the calculated alarm threshold after the alarm count has been reached.
70 Flow chart symbol showing a process block, where an alarm condition is to be announced, either locally if operating as a standalone unit, or remotely if connected to a remote panel.

### REFERENCES

REF: Carlson, Shawn. “Counting Atmospheric Ions”, sciam.com, accessed Jul. 6, 2009, <http://www.scientificamerican.com/article.cfm?id=counting-atmospheric-ions>
REF: Dziekan, Mike. “Where there's smoke, there's (not always) fire—An Inside Look at Smoke Detectors”, sas.org/tcs, accessed Jul. 6, 2009, <http://www.sas.org/tcs/weeklyIssues/2004-07-23/feature1/index.html>

What is claimed:

1. An ionization chamber comprising,
a hollow cylindrical chamber having an internal particle travel distance of more than 1 cm but less than 10 cm;
a conductive electrode at one end of the cylindrical chamber held at a positive electric potential,
a conductive electrode at the opposing end of the cylindrical chamber held at a negative electric potential,
a means of accurately measuring ionization current produced when radioactive particles or atmospheric ions enter the sensing volume of the cylindrical chamber.

2. A sampling ionization chamber comprising,
an ionization chamber as in claim 1 where the sensing volume is utilized for sampling for airborne particles and is allowed access to ambient air external to the sensing volume at atmospheric pressure.

3. A reference ionization chamber comprising,
an ionization chamber as in claim 1 where the sensing volume is utilized for reference for sampling only air molecules and water vapor, while preventing airborne particles from entering the sensing volume and is allowed restricted access to ambient air external to the sensing volume at atmospheric pressure.

4. A radioactive particle sensor comprising,
a sampling ionization chamber as in claim 2 where the ionization current is measured in real-time and recorded for processing,
a reference ionization chamber as in claim 3 where the ionization current is measured in real-time and recorded for processing,
a means of processing the recorded sampling ionization current data over time determining a time varying alarm threshold,
a means of processing the recorded reference ionization current data over time determining a time varying alarm threshold,
a means of conveying a radioactive particle alarm condition indicative of radioactive particles within the sampling ionization chamber or a source of ionizing radiation within close proximity to either the sampling ionization chamber or the reference ionization chamber due to a rapid increased magnitude of ionization current above the calculated time varying alarm threshold,
a means of conveying a radon gas alarm condition indicative of radon gas within the reference ionization chamber where the sampling ionization chamber is temporarily closed off from ambient air that is external to the sampling ionization chamber and there is a gradual buildup of background ionization current in the reference ionization chamber.

5. A means of indicating a radioactive particle alarm condition whereby,
a visual alarm indication is indicated by means of a strobe embedded into the radioactive particle sensor described in claim 4,
an audible alarm indication is indicated by means of a loud sounder, buzzer, or piezo embedded into the radioactive particle sensor described in claim 4,
a silent alarm indication is indicated by means of a contact closure from a normally open relay embedded into the radioactive particle sensor described in claim 4,
a silent alarm indication is indicated by means of a contact opening from a normally closed relay embedded into the radioactive particle sensor described in claim 4,
a silent alarm indication is indicated by means of a wireless radio frequency transmitter embedded into the radioactive particle sensor described in claim 4,
a silent alarm indication is indicated by means of a wireless optical transmitter embedded into the radioactive particle sensor described in claim 4.

6. A means of indicating a radon gas alarm that is distinct from the radioactive particle alarm whereby,
a visual alarm indication is indicated by means of a strobe embedded into the radioactive particle sensor described in claim 4,
an audible alarm indication is indicated by means of a loud sounder, buzzer, or piezo embedded into the radioactive particle sensor described in claim 4,
a silent alarm indication is indicated by means of a contact closure from a normally open relay embedded into the radioactive particle sensor described in claim 4,
a silent alarm indication is indicated by means of a contact opening from a normally closed relay embedded into the radioactive particle sensor described in claim 4,
a silent alarm indication is indicated by means of a wireless radio frequency transmitter embedded into the radioactive particle sensor described in claim 4,
a silent alarm indication is indicated by means of a wireless optical transmitter embedded into the radioactive particle sensor described in claim 4.
